(19) United States
(12) Patent Application Publication
(10) Pub. No.: US 2011/0202201 A1
(43) Pub. Date: Aug. 18, 2011

(54) REMOTE STARTING DEVICE AND REMOTE STARTING METHOD

(75) Inventor: Manabu MATSUBARA, Kobe-shi (JP)

(73) Assignee: FUJITSU TEN LIMITED, Kobe-Shi (JP)

(21) Appl. No.: 13/020,397

(22) Filed: Feb. 3, 2011

(30) Foreign Application Priority Data
Feb. 12, 2010 (JP) 2010-029428
Sep. 29, 2010 (JP) 2010-218317

(51) Int. Cl. F02N 11/08

(52) U.S. Cl. 701/2

(57) ABSTRACT

A remote starting device starts up an engine of a vehicle when receiving an engine starting signal wirelessly transmitted from a remote control terminal. A starting control unit turns on a remote control switch disposed in a path through which power is supplied to ignition devices from a battery to supply power to the ignition devices and to start up the engine when receiving the engine starting signal. An operation state detecting unit detects at least a key insertion operation of inserting a key into a key cylinder and a brake pedaling operation of depressing a brake pedal, by an operator. A remote control stopping unit turns off the remote control switch when stopping of the brake pedaling operation is detected after the engine is started up and the key insertion operation and the brake pedaling operation are detected.

The disclosure of Japanese Patent Applications No. 2010-029428 filed on Feb. 12, 2010 and No. 2010-218317 filed on Sep. 29, 2010, including specifications, drawings and claims are incorporated herein by reference in their entireties.

### BACKGROUND

The present invention relates to a technique of starting up an engine mounted on a vehicle in response to an RF signal transmitted from a remote control terminal.

The present invention also relates to a remote starting device which automatically starts up an engine when receiving an engine starting signal wirelessly transmitted from a remote control terminal outside a vehicle.

There is a remote starting control technique of starting up an engine mounted on a vehicle by a user's operation of a remote control terminal in a remote place to warm up the engine until the user boards the vehicle. By using this technique, the engine has been warmed up when the user boards the vehicle in cold climates. Accordingly, the vehicle can be driven forward at once.

In a control device (hereinafter, referred to as “remote starting device”) starting up an engine mounted on a vehicle by such remote starting, the running of the engine is stopped when a user unlocks a door or when the user opens the door.

When the remote starting device does not stop the running of the engine but continues to run the engine, a third party who is not an authentic user may enter the vehicle and steal the vehicle until an authentic user arrives at the location of the vehicle from a remote place after remotely starting up the engine.

However, from the viewpoint of a user, since the engine remotely once started up is stopped at the time of boarding the vehicle, the user has to be started up the engine again after boarding the vehicle, which is inconvenient.

In order to solve the inconvenience in using such a vehicle, JP-A-2009-255836 discloses a technique of a remote starting device continuing to run an engine of a vehicle after a user remotely starts up the engine, opens a door of the vehicle, and boards the vehicle.

Thereafter, when a given operation is performed by the user, the remote starting device can continue to run the engine without stopping the running of the engine.

Thereafter, when another given operation is performed by the user, the remote starting device stops the running of the engine.

An example of a given operation is a user's operation of pedaling a foot brake after performing an operation (hereinafter, referred to as “driving start operation”) of starting the driving of a vehicle.

An example of another given operation is a user's operation of first pedaling a foot brake.

On the other hand, when the engine of a vehicle is directly started up to start the driving of the vehicle without remotely starting up the engine of the vehicle, a user performs a driving start operation after boarding the vehicle and pedaling the foot brake (hereinafter, referred to as “normal driving start operation”)

However, some users perform the normal driving start operation even when they board a vehicle after remotely starting up the engine of the vehicle. That is, some users first pedal a brake and then perform the driving start operation after they remotely start up the engine of the vehicle and then board the vehicle.

In this case, since the user pedals the brake after boarding the vehicle, the remote starting device does not continue but stops the running of the engine.

Therefore, the running of the vehicle engine is stopped against the user's will for continuing to run the engine, and thus the inconvenience in using the vehicle is not resolved.

There is a vehicle mounted with a remote starting device starting an engine by operating a remote control terminal carried by a user outside the vehicle so as to warm up an engine or to air-condition a vehicle interior before driving the vehicle. The remote starting device starts up an engine in response to an engine starting signal wirelessly transmitted from the remote control terminal.

In order to prevent the theft of a vehicle when a third party enters a vehicle in which the engine has been started up by the use of the remote starting device, the remote starting device stops the engine when it detects boarding operations such as unlocking a vehicle door or opening a vehicle door.

Accordingly, an authentic user needs to insert a key into a key cylinder and to restart the engine by turning the key after boarding the vehicle.

JP-A-2009-255836 discloses a remote starting device including engine starting means for wirelessly receiving a starting instruction signal for instructing the start up of an engine of a vehicle and changing a control signal for starting up the engine to an ON state in response to the starting instruction signal and operation monitoring means for monitoring a given user operation carried out on the vehicle after the control signal is changed to the ON state. Here, the engine starting means keeps the control signal in the ON state until the user operation is ended after the control signal is changed to the ON state, and changes the control signal to an OFF state when a user operation of running the given part of the vehicle is carried out without using a portable key.

In the technique described in JP-A-2009-255836, it is possible to provide a vehicle which can prevent the theft of the vehicle by a third party while improving the convenience of the user operation, by entering a driving-enabled state without stopping the engine in a state where the engine is started up remotely.

In general, when a key is inserted into a key cylinder and the key is then turned, an accessory power switch connecting a battery to an accessory circuit is first turned on, an ignition switch connecting the battery to an ignition circuit is then turned on, and a starter switch connecting the battery to a starter circuit is turned on, whereby the engine is started up.

The remote starting device includes plural remote-starting switch circuits connecting the battery to various circuits in addition to switches such as the accessory power switch, the ignition switch, and the starter switch and starts up the engine by turning off the remote-starting switch circuits when receiving an engine starting signal wirelessly transmitted from the remote control terminal.

The remote starting device described in JP-A-2009-255836 includes a detector circuit that detects an operation position of the key inserted into the key cylinder in the state where the engine is remotely started up, and enters a driving-enabled state without stopping the engine in the state where the engine is remotely started up when detecting that the key is operated through the use of the detector circuit.

The remote starting device described in JP-A-2009-255836 keeps the control signal in the ON state until given user operations such as unlocking a door, opening a door, boarding, closing a door, and turning on an ignition switch are ended, but changes the control signal to the OFF state to stop the engine when a brake pedaling operation is carried out in the meantime.

However, since the remote starting device disclosed in JP-A-2009-255836 enters a driving-enabled state without stopping the engine in the state where the engine is remotely started up, the detector circuit detecting that the key is operated and the ignition switch is turned on is necessary, thereby increasing the cost.

From a viewpoint other than described above, a user generally pedals a brake after turning a key and switches a shift lever from a parking range to a driving range, but a user is not limited to such a procedure and may turn the key after pedaling the brake. In this case, since the control signal is changed to the OFF state by the remote starting device at the time of pedaling the brake, it is necessary to restart the engine by turning the key, which means that there is room for further improvement.

### SUMMARY

It is therefore a first object of at least one embodiment of the present invention to provide a technique of not stopping the running of an engine against a user's will when the user remotely starts up the engine of a vehicle and then boards the vehicle.

It is a second object of at least one embodiment of the present invention to provide a remote starting device which can enter a driving-enabled state without stopping an engine in a state where the engine is remotely started up without employing a detector circuit detecting that a key is operated.

In order to achieve at lease one of the above-described objects, according to a first aspect of the embodiments of the present invention, there is provided a remote starting device that starts up an engine of a vehicle when receiving an engine starting signal wirelessly transmitted from a remote control terminal, the remote starting device comprising: a starting control unit that turns on a remote control switch disposed in a path through which power is supplied to ignition devices from a battery to supply power to the ignition devices and to start up the engine when receiving the engine starting signal; an operation state detecting unit that detects at least a key insertion operation of inserting a key into a key cylinder and a brake pedaling operation of depressing a brake pedal, by an operator; and a remote control stopping unit that turns off the remote control switch when stopping of the brake pedaling operation is detected after the engine is started up and the key insertion operation and the brake pedaling operation are detected.

With this configuration, the remote starting device turns on the remote control switch which is disposed in the path through which power is supplied to the ignition devices from the battery to supply power to the ignition devices and to start up the engine, when the signal for starting up the engine of the vehicle is received from the remote control terminal. The remote starting device detects at least the user's operation of inserting the key into the key cylinder and the brake pedaling operation, and turns off the remote control switch when the stopping of the brake pedaling operation is detected after starting up the engine and detecting the insertion of the key and the brake pedaling operation.

Accordingly, the remote starting device can disable stopping the running of an engine against a user's will when the user performs a driving start operation after the user remotely starts up the engine of a vehicle and then boards the vehicle.

The remote starting device may further comprise: an authentication unit that authenticates a signal transmitted from one of a wireless key and a smart key; and an unlocking unit that allows a door of the vehicle to be unlocked when a result of the authentication by the authentication unit is a success. The remote control stopping unit may turn off the remote control switch when the stopping of the brake pedaling operation is detected after the key insertion operation and the brake pedaling operation are detected in a state where the engine is started up and the door is allowed to be unlocked.

With this configuration, when the result of the authentication on the signal transmitted from one of the wireless key and the smart key is success, the remote starting device unlocks the door of the vehicle. The remote starting device turns off the remote control switch when the stopping of the brake pedaling operation is detected after the insertion of the key and the brake pedaling operation are detected in the state where the engine is started up and the door of the vehicle is unlocked.

Accordingly, the remote starting device can turn off the remote control switch on the basis of the authentic user's operation.

The operation state detecting unit may further detect a position of a shift lever operated by the operator, and the remote control stopping unit may turn off the remote control switch when it is detected that the position of the shift lever is disengaged from a perking position after the engine is started up and the key insertion operation and the brake pedaling operation are detected.

With this configuration, the remote starting device turns off the remote control switch when it is detected that the position of the shift lever is disengaged from “P” (the perking position) after the engine is started up and the insertion and the brake pedaling operation are detected.

Accordingly, the remote starting device turns off the remote control switch and stops the running of the engine in the driving-enabled state in which the position of the shift lever is disengaged from “P”, whereby it is possible to express that the position of the shift lever cannot be disengaged from “P” at this time.

The remote control stopping unit may turn off the remote control switch when the insertion of the key is not detected after the engine is started up and the key insertion operation and the brake pedaling operation are detected.

With this configuration, the remote starting device turns off the remote control switch when the insertion of the key is not detected any more after the engine is started up and the insertion of the key and the brake pedaling operation are detected.

Accordingly, the remote control device can determine the user's intention of not driving the vehicle on the basis of the fact that the insertion of the key is not detected any more after the insertion of the key has been detected. The remote starting device can turn off the remote control switch on the basis of the determination to stop the running of the engine.

According to a second aspect of the embodiments of the present invention, there is provided a remote starting device that starts up an engine of a vehicle when receiving an engine starting signal wirelessly transmitted from a remote control terminal, the remote starting device comprising: a starting control unit that starts up the engine by remote control when receiving the engine starting signal; an operation state detecting unit that detects at least a switch operation on a power supply switch of a vehicle system and a brake pedaling operation of depressing a brake pedal, by an operator; and a remote control stopping unit that stops the remote control when the switch operation is detected after the engine is started up and the brake pedaling operation is then detected.

With this configuration, the remote starting device starts the engine by the remote control when receiving the engine starting signal, and detects at least the operator's operation on the power supply switch of the vehicle system and the brake pedaling operation. The remote starting device stops the remote control when the operation on the power supply switch is detected after the engine is started up and the break pedaling operation is detected.

Accordingly, the remote starting device can disable stopping the running of an engine against a user's will when the user performs a driving start operation after the user remotely starts up the engine of a vehicle and then boards the vehicle.

The remote control stopping unit may stop the remote control when the switch operation is detected after the engine is started up.

With this configuration, the remote starting device stops the remote control when the operation of the power supply switch is detected after the engine is started up.

Accordingly, the remote starting device can disable stopping the running of an engine against a user's will when the user performs a driving start operation after the user remotely starts up the engine of a vehicle and then boards the vehicle.

According to the third aspect of the embodiments of the present invention, there is provided a remote starting method for starting up an engine of a vehicle when receiving an engine starting signal wirelessly transmitted from a remote control terminal, the remote starting method comprising: (a) turning on a remote control switch disposed in a path through which power is supplied to ignition devices from a battery to supply power to the ignition devices and to start up the engine when receiving the engine starting signal; (b) detecting at least a key insertion operation of inserting a key into a key cylinder and a brake pedaling operation of depressing a brake pedal, by an operator; and (c) turning off the remote control switch when stopping of the brake pedaling operation is detected after the engine is started up and the key insertion operation and the brake pedaling operation are detected.

With this configuration, the remote starting method turns on the remote control switch which is disposed in the path through which power is supplied to the ignition devices from the battery to supply power to the ignition devices and to start up the engine, when the signal for starting up the engine of the vehicle is received from the remote control terminal. The remote starting method detects at least the user's operation of inserting the key into the key cylinder and the brake pedaling operation, and turns off the remote control switch when the stopping of the brake pedaling operation is detected after starting up the engine and detecting the insertion of the key and the brake pedaling operation.

Accordingly, the remote starting method can disable stopping the running of an engine against a user's will when the user performs a driving start operation after the user remotely starts up the engine of a vehicle and then boards the vehicle.

According to a fourth aspect of the embodiments of the present invention, there is provided a remote starting method for starting up an engine of a vehicle when receiving an engine starting signal wirelessly transmitted from a remote control terminal, the remote starting method comprising: (a) starting up the engine by remote control when receiving the engine starting signal; (b) detecting at least a switch operation on a power supply switch of a vehicle system and a brake pedaling operation of depressing a brake pedal, by an operator; and (c) stopping the remote control when the switch operation is detected after the engine is started up and the brake pedaling operation is then detected.

With this configuration, the remote starting method starts the engine by the remote control when receiving the engine starting signal, and detects at least the operator's operation on the power supply switch of the vehicle system and the brake pedaling operation. The remote starting method stops the remote control when the operation on the power supply switch is detected after the engine is started up and the break pedaling operation is detected.

Accordingly, the remote starting method can disable stopping the running of an engine against a user's will when the user performs a driving start operation after the user remotely starts up the engine of a vehicle and then boards the vehicle.

According to a fifth aspect of the embodiments of the present invention, there is provided a remote starting device that starts up an engine of a vehicle when receiving an engine starting signal wirelessly transmitted from a remote control terminal, the remote starting device comprising: a starting control unit that turns on a remote control switch disposed in a path through which power is supplied to ignition devices from a battery to supply power to the ignition devices and to start up the engine when receiving the engine starting signal; an operation state detecting unit that detects at least a key insertion operation of inserting a key into a key cylinder and a brake pedaling operation of depressing a brake pedal, by an operator; and a remote control stopping unit that turns off the remote control switch when the key insertion operation and the brake pedaling operation are detected by the operation state detecting unit after the engine is started up by the starting control unit.

According to this configuration, when the insertion of a key into a key cylinder and the brake pedaling operation are detected after the engine is started up by the starting control unit, it is determined that an ignition switch is turned on by the key operation and the remote control switch is turned off by the remote control stopping unit. Accordingly, it is possible to enter a driving-enabled state without stopping the engine without employing a detector circuit detecting that the ignition switch is turned on by a key.

The remote control stopping unit may turn off the remote control switch when the key insertion operation is detected and then the brake pedaling operation is detected by the operation state detecting unit.

The remote control stopping unit may turn off the remote control switch when a predetermined waiting time passes after the brake pedaling operation is detected and then the key insertion operation is detected by the operation state detecting unit. The remote control stopping unit may turn off the remote control switch at once when stopping of the brake pedaling operation is detected in the predetermined waiting time. The remote control stopping unit may turn off the remote control switch when the key insertion operation is not detected in a predetermined waiting time after the brake pedaling operation is detected by the operation state detecting unit.

In general, a user inserts a key, then pedals a brake, and switches a shift lever from a parking range to a driving range, but without being limited to such a procedure, may insert the key into a key cylinder after pedaling the brake.

In this case, instead of turning off the remote control switch at once to stop the engine when the brake pedaling operation is detected by the operation state detecting unit, a predetermined waiting time until the insertion of the key is detected may be set and the remote control switch may be turned off after the waiting time elapses. Accordingly, when a user having a driving intention inserts the key, the engine restarting operation is not necessary, thereby improving the convenience to a user.

When the insertion of the key is not detected within the waiting time by the operation state detecting unit, the remote control switch may be turned off by the remote control stopping unit to stop the engine. In this case, it is also possible to prevent the theft of the vehicle by a third party not having an authentic key.

According to the above-mentioned configurations of the invention, it is possible to provide a remote starting device which can enter a driving-enabled state without stopping an engine in the state where the engine is remotely started up, without employing a detector circuit detecting that a key is operated.

The remote control stopping unit may determine that an ignition switch is turned on by operator's key operation when a predetermined waiting time passes after the key insertion operation is detected by the operation state detecting unit, and then turn off the remote control switch.

The vehicle may be provided with an immobilizer that verifies whether or not the key is an authentic key, the remote control stopping unit may turn off the remote control switch when the predetermined waiting time passes after the key insertion operation is detected by the operation state detecting unit and the immobilizer verifies that the key is the authentic key, and the remote control stopping unit may turn off the remote control switch at once when the immobilizer verifies that the key is not the authentic key.

The remote control stopping unit may turn off the remote control switch at once when a predetermined banned operation is detected by the operation state detecting unit until the remote control switch is turned off.

The remote control stopping unit may turn off the remote control switch at once when the operation state detecting unit detects that the key is pulled out from the key cylinder after the key insertion operation is detected and before the remote control switch is turned off.

The vehicle may be provided with an automatic door locking device, the remote control stopping unit may turn off the remote control switch when a door of the vehicle is unlocked by the automatic door locking device and the key insertion operation is detected by the operation state detecting unit, and the remote control stopping unit may turn off the remote control switch at once when the door is unlocked without using the automatic door locking device.

According to a sixth aspect of the embodiments of the present invention, there is provided a remote starting device that starts up an engine of a vehicle when receiving an engine starting signal wirelessly transmitted from a remote control terminal, the remote starting device comprising: a starting control unit that starts up the engine by remote control when receiving the engine starting signal; an operation state detecting unit that detects at least a switch operation on a power supply switch of a vehicle system and a brake pedaling operation of depressing a brake pedal, by an operator; and a remote control stopping unit that stops the remote control when the engine is started up by the starting control unit, and then the switch operation is detected by the operation state detecting unit before or after the brake pedaling operation is detected by the operation state detecting unit.

The remote control stopping unit may stop the remote control when the switch operation is not detected in a predetermined waiting time after the brake pedaling operation is detected by the operation state detecting unit.

The remote control stopping unit may stop the remote control when stopping of the brake pedaling operation is detected before the switch operation is detected by the operation state detecting unit.

The remote control stopping unit may stop the remote control when a predetermined waiting time passes after the brake pedaling operation is detected and then the switch operation is detected by the operation state detecting unit.

The remote control stopping unit may stop the remote control when the switch operation is detected and then the brake pedaling operation is detected by the operation state detecting unit.

### BRIEF DESCRIPTION OF THE DRAWINGS

In the accompanying drawings:

FIG. 1 is a circuit block diagram of a remote starting device according to a first embodiment of the present invention;

FIG. 2 is a flow diagram illustrating a control procedure of the remote starting device according to the first embodiment;

FIG. 3 is a flow diagram illustrating a control procedure of the remote starting device according to the first embodiment;

FIG. 4 is a flow diagram illustrating a control procedure of a remote starting device according to a second embodiment of the present invention;

FIG. 5 is a circuit block diagram of a remote starting device according to a third embodiment of the present invention;

FIG. 6 is a flow diagram illustrating a control procedure of the remote starting device according to the third embodiment;

FIG. 7 is a flow diagram illustrating a control procedure of a remote starting device according to a fourth embodiment of the present invention;

FIG. 8 is a flow diagram illustrating a control procedure of a remote starting device according to a fifth embodiment of the present invention;

FIG. 9 is a circuit block diagram of a remote starting device according to a sixth embodiment of the present invention;

FIG. 10 is a flow diagram illustrating a control procedure of the remote starting device according to the sixth embodiment;

FIG. 11 is a flow diagram illustrating a driving start operation determining procedure of the remote starting device according to the sixth embodiment;

FIG. 12 is a timing diagram illustrating the driving start operation determining procedure of the remote starting device according to the sixth embodiment;

FIG. 13 is a timing diagram illustrating the driving start operation determining procedure of the remote starting device according to the sixth embodiment;

FIG. 14 is a timing diagram illustrating the driving start operation determining procedure of the remote starting device according to the sixth embodiment;

FIG. 15 is a timing diagram illustrating the driving start operation determining procedure of the remote starting device according to the sixth embodiment;

FIG. 16 is a circuit block diagram of a remote starting device according to another embodiment of the present invention;

FIG. 17 is a flow diagram illustrating a driving start operation determining procedure of the remote starting device according to another embodiment; and

FIG. 18 is a flow diagram illustrating a driving start operation determining procedure of the remote starting device according to another embodiment.

### DETAILED DESCRIPTION OF THE EMBODIMENTS

### First Embodiment

Hereinafter, a vehicle control system according to a first embodiment of the invention will be described with reference to the accompanying drawings.

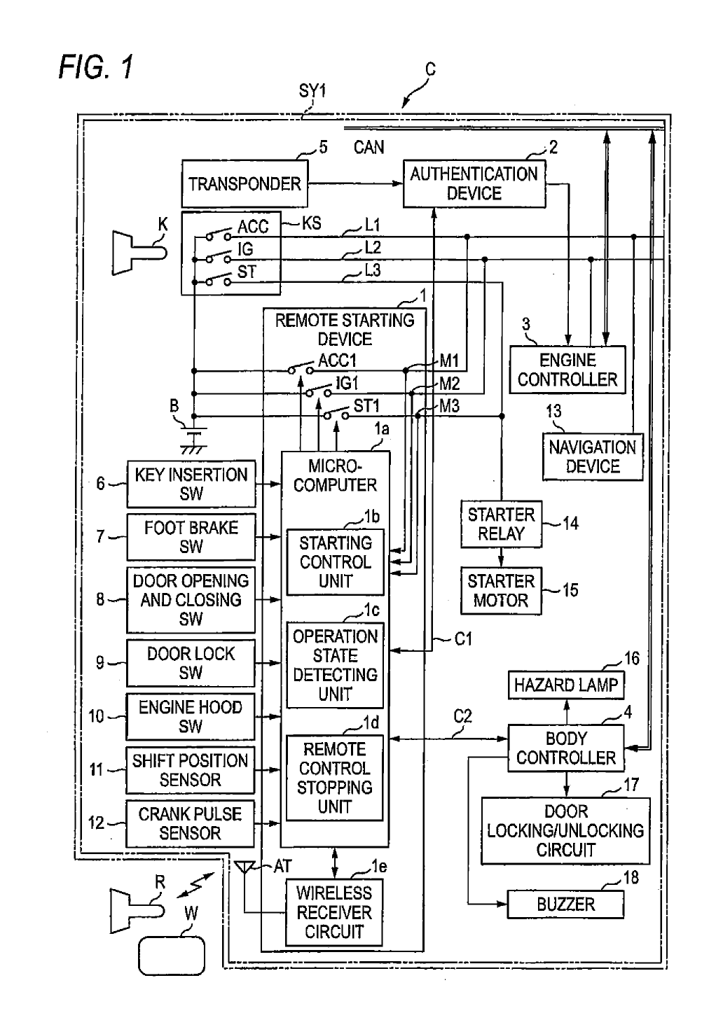

First, the configuration of a system for embodying a technique (hereinafter, also referred to as “remote starting”) of starting up an engine mounted on a vehicle in response to an RF signal transmitted from a remote control terminal, that is, a vehicle control system, will be described with reference to FIG. 1.

<Configuration of Vehicle Control System>

FIG. 1 is a diagram illustrating the configuration of a vehicle control system SY1. The vehicle control system SY1 includes a remote starting device 1, an authentication device 2, an engine controller 3, a body controller 4, a transponder 5, a key insertion switch 6, a foot brake switch 7, a door opening and closing switch 8, a door lock switch 9, an engine hood switch 10, a shift position sensor 11, a crank pulse sensor 12, a navigation device 13, a starter relay 14, a starter motor 15, a hazard lamp 16, a door locking/unlocking circuit 17, and a buzzer 18.

The vehicle control system SY1 electrically connects the remote starting device 1 and the like to each other via signal lines.

The remote starting device 1 includes a microcomputer 1a, an accessory switch ACC1, an ignition switch IG1, a starter switch ST1, and a wireless receiver circuit 1e. The microcomputer 1a includes a starting control unit 1b remotely starting an engine, an operation state detecting unit 1c detecting operation states of a vehicle C, and a remote control stopping unit 1d stopping the started-up engine. The details of the control performed by the starting control unit 1b and the like will be described later.

The microcomputer 1a further includes, for example, a ROM storing a program of the control performed by the starting control unit 1b and the like, a CPU executing the program stored in the ROM, and a RAM serving as a working area when the CPU executes the program.

The accessory switch ACC1 is a switch supplying or intercepting power from a battery B to accessories of the vehicle C when the remote starting device 1 remotely starts up the engine.

The ignition switch IG1 is a switch supplying or intercepting power from the battery B to electrical devices other than the accessories of the vehicle C when the remote starting device 1 remotely starts up the engine.

The starter switch ST1 is a switch supplying or intercepting power from the battery B to the starter motor 15 of the vehicle C via the starter relay 14 when the remote starting device 1 remotely starts up the engine.

The wireless receiver circuit 1e is a circuit receiving a signal wirelessly transmitted from a remote control terminal RC.

The authentication device 2 performs an authentication process on the basis of the an ID signal wirelessly received from a user key K when the user key K which is a key necessary for starting the driving of the vehicle C is inserted into a key cylinder KS of the vehicle C by a user. The details of the authentication process will be described later.

The engine controller 3 controls the running of the engine of the vehicle C. Specifically, the engine controller 3 controls an ignition plug, an injector, and a throttle motor of the vehicle C to control the running of the engine.

The body controller 4 controls the hazard lamp 16, the door locking/unlocking circuit 17, and the buzzer 18 on the basis of the authentication result received from the authentication device 2. For example, the body controller 4 controls the hazard lamp or the buzzer 18 to externally inform of the theft of the vehicle C when the authentication result received from the authentication device 2 is “failure”.

The transponder 5 is a receiver wirelessly receiving the ID signal from the user key K when the user key K is inserted into the key cylinder KS of the vehicle C by the user. The transponder 5 transmits the received ID signal to the authentication device 2 via a signal line.

The key insertion switch 6 detects the insertion state of the user key K and outputs the detection result to the remote starting device 1.

The foot brake switch 7 detects the user's operation on the foot brake switch 7 and outputs the detection result to the remote starting device 1 and the like.

The door opening and closing switch 8 detects the opening and closing state of a door and outputs the detection result to the remote starting device 1 and the like. The door opening and closing switch 8 is, for example, a courtesy switch.

The door lock switch 9 detects the locking/unlocking state of the door and outputs the detection result to the remote starting device 1 and the like.

The engine hood switch 10 detects the opening and closing state of an engine hood and outputs the detection result to the remote starting device 1 and the like.

The shift position sensor 11 detects a position of a shift lever and outputs the detection result to the remote starting device 1 and the like.

The crank pulse sensor 12 detects sawteeth of a rotation shaft of the engine and outputs the detected pulse signal to the remote starting device 1 and the like.

The navigation device 13 includes a display unit and a recording unit in which map information and the like are recorded. The navigation device 13 displays a current position of the vehicle C on the display unit along with a map.

The starter relay 14 is a relay supply power from the battery 13 to the starter motor 15 when a starter switch ST or a starter switch ST1 is turned on.

The starter motor 15 is a motor assisting the rotary power of the engine when the remote starting device 1 or the engine controller 3 cranks the engine.

The hazard lamp 16 is a lamp flickering under the control of the body controller 4. The hazard lamp 16 flickers to warn the periphery of the vehicle C.

The door locking/unlocking circuit 17 locks or unlocks a door of the vehicle C on the basis of a signal from the body controller 4.

The buzzer 18 is a buzzer ringing under the control of the body controller 4. The buzzer 18 rings to warn the periphery of the vehicle C.

The key cylinder KS is mounted in the vicinity of a steering wheel of the vehicle C. The key cylinder KS includes an accessory switch ACC, an ignition switch IC, and a starter switch ST.

The accessory switch ACC is turned on in the key cylinder KS when the user key K is inserted into the key cylinder KS by the user and the user key K is turned up to the position where the accessory switch ACC is turned.

The ignition switch IG is turned on when the key inserted into the key cylinder KS is turned up to the position where the ignition switch IG is turned on by the user.

The starter switch ST is turned on when the key inserted in the key cylinder KS is turned up to the position where the starter switch ST is turned on by the user.

The vehicle control system SY1 having the above-mentioned configuration performs various procedures. Various procedures include, for example, an engine starting procedure of normally starting up the engine without remotely starting up the engine, an authentication procedure of authenticating the ID signal wirelessly received from the user key K or the like, a remote engine starting procedure of starting up the engine by remote control, and a remote starting control stopping procedure of stopping the remote engine starting procedure.

Details thereof will be described below.

<Engine Starting Procedure>

An engine starting procedure will be first described. The engine starting procedure is embodied mainly by the user key K, the key cylinder KS, the starter relay 14, the starter motor 15, the engine, and the engine controller 3.

A user inserts the user key K into a key insertion hole of the key cylinder KS and turns the user key up to a position where the starter switch ST is turned on. In the vehicle control system SY1, when the starter switch ST is turned on, the battery B is electrically connected to the starter motor 15 and thus the starter motor 15 is activated. That is, the user can activate the starter motor 15 by turning the user key K to turn on the starter switch ST.

Therefore, the user starts up the engine by determining that the rotation rate of the engine reaches a predetermined rotation rate (for example, 1000 rpm) on the basis of an engine sound and the like and stopping the turning operation.

On the other hand, the engine controller 3 controls the ignition plug, the injector, and the throttle motor of the engine to start up the engine when receiving a starter switch signal. The engine controller 3 controls the ignition plug or the injector with the assistance of the starter motor until the engine rotation rate determined on the basis of the signal received from the crank pulse sensor 12 reaches a predetermined rotation rate. That is, the engine controller 3 performs the cranking control.

<Authentication Procedure>

The authentication procedure will be then described. The authentication procedure is mainly embodied by the remote control terminal RC, the wireless key W, the user key K, an antenna AT, the transponder 5, the authentication device 2, and the engine controller 3.

The authentication procedure using the user key K will be described below. When the user inserts the user key K into the key insertion hole, the transponder 5 wirelessly receives an ID signal from the user key K. The transponder 5 transmits the received ID signal to the authentication device 2.

The authentication device 2 determines whether the received ID signal is matched with an ID signal stored in advance, and transmits a signal representing “success” as the authentication result to the engine controller 3 when both are matched with each other.

When both are not matched with each other, the authentication device 2 transmits a signal representing “failure” as the authentication result to the engine controller 3. The engine controller 3 performs an engine starting process when receiving the starter switch signal and the signal representing “success” as the authentication result.

The authentication procedure using the wireless key W will be described below. The user operates the wireless key W to transmit an instruction signal for unlocking the door of the vehicle C and the ID signal to the vehicle control system SY1. At this time, the authentication device 2 of the vehicle control system SY1 receives the instruction signal for unlocking the door via the antenna AT.

The authentication device 2 determines whether the ID signal received along with the instruction signal for unlocking the door is matched with the ID signal stored in advance, and transmits the signal representing “success” as the authentication result to the body controller 4 when both are matched with each other.

The authentication device 2 transmits the signal representing “failure” as the authentication result to the body controller 4 when both are not matched with each other.

The body controller 4 unlocks the door of the vehicle C when receiving the signal representing “success” as the authentication result, and does not unlock the door of the vehicle C when receiving the signal representing “failure” as the authentication result.

Therefore, since the vehicle control system SY1 unlocks the door of the vehicle C, the user can open the door by pulling a knob on the door.

The authentication procedure using the remote control terminal RC will be described below. The user operates the remote control terminal RC to transmit a signal instructing to start up the engine to the vehicle control system SY1.

At this time, the remote starting device 1 of the vehicle control system SY1 receives the signal instructing to start up the engine via the antenna AT and the wireless receiver circuit 1e. The remote starting device 1 transmits the ID signal included in the signal instructing to start up the engine to the authentication device 2.

The authentication device 2 determines whether the received ID signal is matched with the ID signal stored in advance, and transmits the signal representing “success” as the authentication result to the engine controller 3 when both are matched with each other.

The authentication device 2 transmits the signal representing “failure” as the authentication result to the engine controller 3 when both are not matched with each other.

The engine controller 3 performs a remote engine starting procedure when receiving the starter switch signal. The engine controller 3 performs a process of informing the outside of the theft of the vehicle C when receiving the starter switch signal and the signal representing “failure” as the authentication result. The process of information the outside of the theft of the vehicle C will be described later.

<Remote Engine Starting Procedure>

The remote engine starting procedure will be described below.

The remote engine starting procedure is mainly embodied by the remote control terminal RC, the antenna AT, the remote starting device 1, the starter relay 14, the starter motor 15, and the engine controller 3.

When the user operates an engine starting button of the remote control terminal RC, the remote control terminal RC wirelessly transmits a starting signal to the remote starting device 1 mounted on the vehicle C in response to the operation.

The starting control unit 1b of the remote starting device 1 starts up the engine on the basis of the starting signal received via the antenna AT and the wireless receiver circuit 1e.

At the time of remotely starting up the engine, the remote starting device 1, determines that the vehicle state is a state where the engine can be warmed up when a predetermined condition is satisfied after receiving the starting signal, and turns on the accessory switch ACC1, the ignition switch IG1, and the starter switch ST1 thereof.

In response to the turning-on of the switches, the vehicle control system SY1 supplies power from the battery B to an accessory electrical device, a non-accessory electrical device, and the starter motor 15.

Examples of the predetermined conditions include a condition that the key is not inserted on the basis of the signal from the key insertion switch 6, a condition that the foot brake is not pedaled on the basis of the signal from the foot brake switch 7, a condition that the engine hood is not opened on the basis of the signal from the engine hood switch 10, a condition that the position of the shift lever is selected as “P” (a perking position) on the basis of the signal from the shift position sensor 11, and a condition that the door is not opened on the basis of the signal from the door lock switch 9.

The accessory electrical device is a control device controlling power windows of the vehicle C, wipers, an audio, a room light, and the like. The non-accessory electrical device is a control device controlling a steering wheel, a transmission, a foot brake, and the like.

An electrical device supplied with power from the battery B in response to the turning-on of the ignition switch IG or the ignition switch IG1 is called ignition device. That is, the ignition switch IG or the ignition switch IG1 is disposed in a path through which power is supplied to the ignition device from the battery B.

The vehicle control system SY1 has two modes of a normal mode and a run-on mode in performing the remote engine starting procedure. The modes can be selected by the user using a switch disposed in the remote control terminal RC or the vehicle. The details of the modes will be described below.

(Normal Mode)

The normal mode will be first described. It is assumed that the normal mode is set in the vehicle control system SY1 by the user. Then, when the engine of the vehicle C is remotely started up by the user's operation on the remote control terminal RC and then the user opens the door of the vehicle C and boards the vehicle C, the vehicle control system SY1 stops the running of the engine.

Accordingly, even when a non-authentic user intends to intrude into the vehicle C and to drive and steal the vehicle C of which the engine is being run until the user boards the vehicle C after remotely starting up the engine of the vehicle C by the use of the remote control terminal RC in a remote place, the running of the engine is stopped at the time of opening the door of the vehicle C, thereby preventing such theft.

On the other hand, since the engine of the vehicle C remotely started up once by the use of the remote control terminal RC is stopped with the boarding, the user has to restart the engine at the time of boarding the vehicle C, which is inconvenient to the user.

(Run-on Mode)

Then, the run-on mode will be described. It is assumed that the vehicle control system SY1 is set to the run-on mode by the user. Then, even when the user remotely starts up the engine of the vehicle C with the operation on the remote control terminal RC, then unlocks the door of the vehicle C by the remote operation, opens the door, and boards the vehicle C, the vehicle control system SY1 does not stop the running of the engine but continues to run the engine.

When a predetermined operation is performed by the user after the user boards the vehicle C, the vehicle control system SY1 continues to run the engine to drive the vehicle. When another predetermined operation is performed at this time, the vehicle control system SY1 stops the running of the engine.

Conventionally, an example of the predetermined operation is the user's operation of starting the driving of the vehicle C (hereinafter, referred to as “driving start operation”). That is, the driving start operation is a user's operation of pedaling the foot brake after the user inserts the user key K into the key cylinder KS and turns on the ignition switch IG.

Conventionally, an example of another predetermined operation is a user's operation of first pedaling the foot brake.

On the other hand, when the vehicle C starts the running without remotely starting up the engine of the vehicle C, the user boards the vehicle C, pedals the foot brake, inserts the user key K into the key cylinder KS, and turns on the ignition switch IG and the starter switch ST.

However, some users may perform a normal driving start operation even after they remotely start up the engine of the vehicle C and then board the vehicle C. That is, some users perform the driving start operation after remotely starting up the engine of the vehicle C, boarding the vehicle C, and then pedaling the foot brake.

In this case, since the user boards the vehicle C and then pedals the foot brake, the remote starting device 1 does not continue to run the engine but stops the running of the engine.

Therefore, the running of the engine is stopped against the user's will of continuing to run the engine and thus the convenience of the run-one mode cannot be enjoyed.

Therefore, the remote starting device 1 of the vehicle control system SY1 improves the convenience in using the vehicle C in the run-on mode by performing the following remote starting control stopping procedure.

<Remote Starting Control Stopping Procedure>

A remote starting control stopping procedure will be described below.

The remote starting control stopping procedure is mainly embodied by the remote starting device 1, the key insertion switch 6, the foot brake switch 7, and the engine controller 3.

The starting control unit 1b of the remote starting device 1 performs the above-mentioned remote starting procedure in response to an RF signal from the remote control terminal RC to start up the engine of the vehicle C.

Thereafter, the operation state detecting unit 1c of the remote starting device 1 stops the running control of the engine by the use of the remote control stopping unit 1d and causes the engine controller 3 to control the running of the engine, when detecting a specific signal.

That is, the operation state detecting unit 1c of the remote starting device 1 detects that the user key K is inserted into the key cylinder KS on the basis of the signal from the key insertion switch 6 which is a specific signal.

The operation state detecting unit 1c of the remote starting device 1 detects that the foot brake is pedaled on the basis of the signal from the foot brake switch 7 which is a specific signal.

The operation state detecting unit 1c of the remote starting device 1 detects that the foot brake is changed from a pedaled state to a non-pedaled state on the basis of the signal from the foot brake switch 7 which is a specific signal after detecting the above-mentioned states.

When the above-mentioned facts are detected by the operation state detecting unit 1c, the remote control stopping unit 1d of the remote starting device 1 turns off the ignition switch IG1 and the accessory switch ACC1 to changes the engine from the remotely-started state to the normal engine control state by the engine controller 3.

Hereinafter, the user's operation of causing a specific signal to be generated in the vehicle C is referred to as “driving start operation”.

Accordingly, even when the user performs the normal driving start operation after the user remotely starts up the engine of the vehicle C and then boards the vehicle C, the engine of the vehicle C is not stopped as long as the user inserts the user key K into the key cylinder KS. That is, the running of the engine is not stopped against the user's will of continuing to run the engine of the vehicle C.

<Flow of Control Procedure>

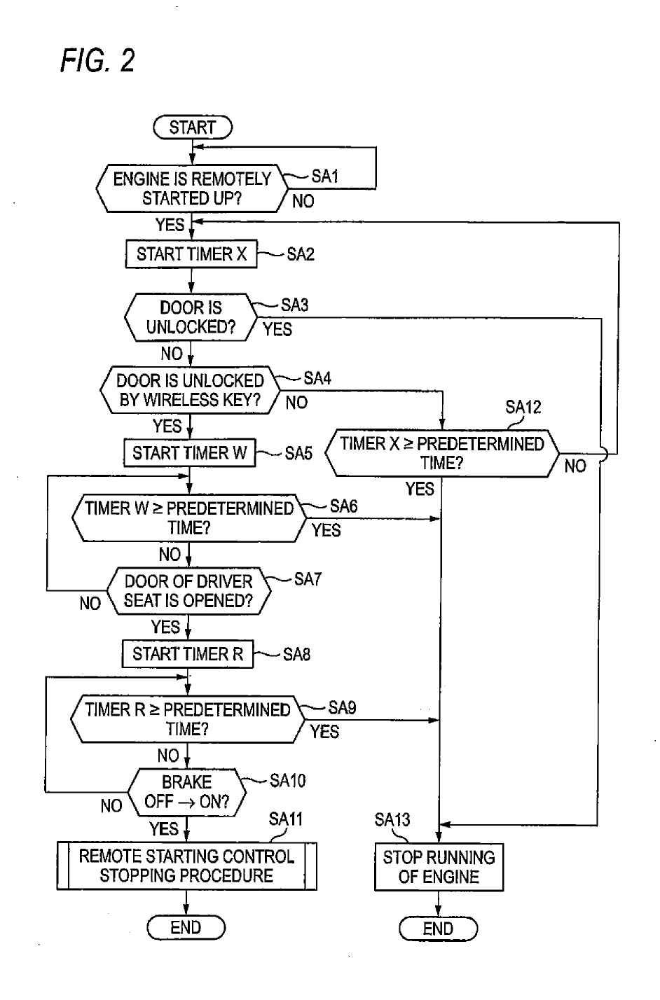

A procedure of stopping the remote starting control and performing the normal engine control under the control of the engine controller 3 after the remote starting device 1 of the vehicle control system SY1 controls the remote starting of the engine of the vehicle C will be described in detail with reference to the flow diagram of FIG. 2.

Here, it is assumed that the vehicle control system SY1 is set to the run-on mode in advance by the user.

Since the remote starting device 1 of the vehicle control system SY1 does not know when receiving the signal instructing to start up the engine from the remote control terminal RC, it is always or periodically supplied with power from the battery B even in the state where other devices are not supplied with power form the battery B.

Therefore, the remote starting device 1 of the vehicle control system SY1 starts the procedure of the main flow shown in FIG. 2 with a predetermined period.

(Main Flow)

The main flow of the flow of the control procedure performed by the vehicle control system SY1 will be first described.

The remote starting device 1 of the vehicle control system SY1 determines whether the engine of the vehicle C is remotely started up (step SA1). That is, the remote starting device 1 determines whether engine is remotely started up by wirelessly receiving the signal instructing to start up the engine from the remote control terminal RC by the user's operation.

When it is determined that the engine of the vehicle C is remotely started up (YES in step SA1), the remote starting device 1 of the vehicle control system SY1 performs the process of step SA2.

At this time, the remote starting device 1 of the vehicle control system SY1 turns on the ignition switch IG1 thereof when the engine is remotely started up. Accordingly, the other devices of the vehicle control system SY1 are supplied with power from the battery B.

The remote starting device 1 of the vehicle control system SY1 starts a timer X thereof (step SA2). The timer X is initialized when the determination result of step SA1 is YES. That is, the timer X is set to 0.

When it is determined that the engine of the vehicle C is not remotely started up (NO in step SA1), the remote starting device 1 of the vehicle control system SY1 repeats the process with a predetermined period.

The remote starting device 1 of the vehicle control system SY1 determines whether the door of the vehicle C is unlocked (step SA3). That is, the remote starting device 1 determines whether the door of the vehicle C is unlocked on the basis of the signal received from the door opening and closing switch 8.

When it is determined that the door of the vehicle C is not unlocked (NO in step SA3), the remote starting device 1 of the vehicle control system SY1 performs the process of step SA4.

The remote starting device 1 of the vehicle control system SY1 determines whether the door of the vehicle C is unlocked by the wireless key W (step SA4).

That is, the remote starting device 1 receives the signal instructing to unlock the door and the ID signal, which are transmitted from the wireless key W by the user's operation, via the wireless receiver circuit 1e and transmits the received ID signal to the authentication device 2. The authentication device 2 performs the above-mentioned authentication procedure on the basis of the received ID signal and transmits the authentication result to the remote starting device 1 and the body controller 4. The body controller 4 unlocks the door of the vehicle C when the received authentication result is “success” and does not unlock the door of the vehicle C when the received authentication result is “failure”.

When it is determined that the door of the vehicle C is unlocked (YES in step SA3), the remote starting device 1 of the vehicle control system SY1 performs the process of step SA13.

In step SA13, the remote starting device 1 of the vehicle control system SY1 performs the control of stopping the running of the engine of the vehicle C (step SA13). That is, the remote starting device 1 performs the remote starting control stopping procedure and transmits the signal for stopping the running of the engine to the engine controller 3. The engine controller 3 stops the running of the engine when receiving the signal for stopping the running of the engine.

When it is determined that the received authentication result is “success” and that the door of the vehicle C is unlocked by the wireless key W (YES in step SA4), the remote starting device 1 performs the process of step SA5.

The remote starting device 1 of the vehicle control system SY1 starts a timer W thereof (step SA5) when it is determined that the door of the vehicle C is unlocked by the wireless key W. The timer W is initialized when the determination result of step SA4 is YES. That is, the timer W is set to 0.

When it is determined that the received authentication result is “failure” and it is not determined that the door of the vehicle C is unlocked by the wireless key W (NO in step SA4), the remote starting device 1 performs the process of step SA12.

When it is determined that the door of the vehicle C is not unlocked by the wireless key W, the remote starting device 1 determines whether the timer X counts up to a predetermined time (step SA12).

When it is determined that the timer X counts up to a predetermined time (YES in step SA12), the remote starting device 1 performs the process of step SA13.

In step SA13, the remote starting device 1 of the vehicle control system SY1 performs the control of stopping the driving of the engine of the vehicle C (step SA13).

When it is determined that the timer X is not counting up to a predetermined time (NO in step SA12), the remote starting device 1 performs the process of step SA2.

The remote starting device 1 of the vehicle control system SY1 determines whether a timer W thereof counts up to a predetermined time (step SA6).

When it is determined that the timer W is not counting up to a predetermined time (NO in step SA6), the remote starting device 1 performs the process of step SA7.

When it is determined that the timer W counts up to a predetermined time (YES in step SA6), the remote starting device 1 performs the process of step SA13. That is, since the long-time maintenance in the unlocked state of the door of the vehicle C by the wireless key W may cause a no-authentic user's theft of the vehicle C, the remote starting device 1 stops the running of the engine of the vehicle C.

In step SA13, the remote starting device 1 of the vehicle control system SY1 performs the control of stopping the running of the engine of the vehicle C (step SA13).

The remote starting device 1 of the vehicle control system SY1 determines whether a door in the vicinity of a driver seat of the vehicle C is opened (step SA7). That is, the remote starting device 1 determines whether the door in the vicinity of the driver seat of the vehicle C is opened on the basis of the signal received from the door opening and closing switch 8.

When it is determined that the door in the vicinity of the driver seat of the vehicle C is opened (YES in step SA7), the remote starting device 1 of the vehicle control system SY1 performs the process of step SA8.

When it is determined that the door in the vicinity of the driver seat of the vehicle C is opened, the remote starting device 1 of the vehicle control system SY1 starts a timer R thereof (step SA8). The timer R is initialized when the determination result of step SA7 is YES. That is, the timer R is set to 0.

When it is determined that the door in the vicinity of the driver seat of the vehicle C is not opened (NO in step SA7), the remote starting device 1 performs the process of step SA13.

In step SA13, the remote starting device 1 of the vehicle control system SY1 performs the control of stopping the running of the engine of the vehicle C (step SA13).

When it is determined that the timer R is not counting up to a predetermined time (NO in step SA9), the remote starting device 1 performs the process of step SA10.

The remote starting device 1 of the vehicle control system SY1 determines whether the foot brake is changed from the pedaled state to the non-pedaled state by the user (step SA10). That is, the remote starting device 1 determines whether the foot brake is changed from the OFF state to the ON state on the basis of the signal received from the foot brake switch 7.

When it is determined that the timer R counts up to a predetermined time (YES in step SA9), the remote starting device 1 performs the process of step SA13.

In step SA13, the remote starting device 1 of the vehicle control system SY1 performs the control of stopping the running of the engine of the vehicle C (step SA13).

That is, since the long-time maintenance in the opened state of the door of the vehicle C by the wireless key W may cause a no-authentic user's theft of the vehicle C, the remote starting device 1 stops the running of the engine of the vehicle C.

When it is determined that the foot brake is changed from the pedaled state to the non-pedaled state by the user (YES in step SA10), the remote starting device 1 performs the process of step SA11.

The remote starting device 1 of the vehicle control system SY1 stops the control of remotely starting up the engine (step SA11).

That is, the remote starting device 1 turns off the accessory switch ACC1 and the ignition switch IG1 thereof at the time of remotely starting up the engine. The details of the “remote starting control stopping procedure” which is performed by the remote starting device 1 when the driving start operation is performed by the user will be described later.

When it is determined that the foot brake is changed from the pedaled state to the non-pedaled state (NO in step SA10), the remote starting device 1 performs the process of step SA9.

In steps SA3, SA6, SA7, SA9, and SA12, the remote starting device 1 stops the running of the engine of the vehicle C so as to prevent a non-authentic user's intrusion into the vehicle C (step SA13).

(Sub Flow)

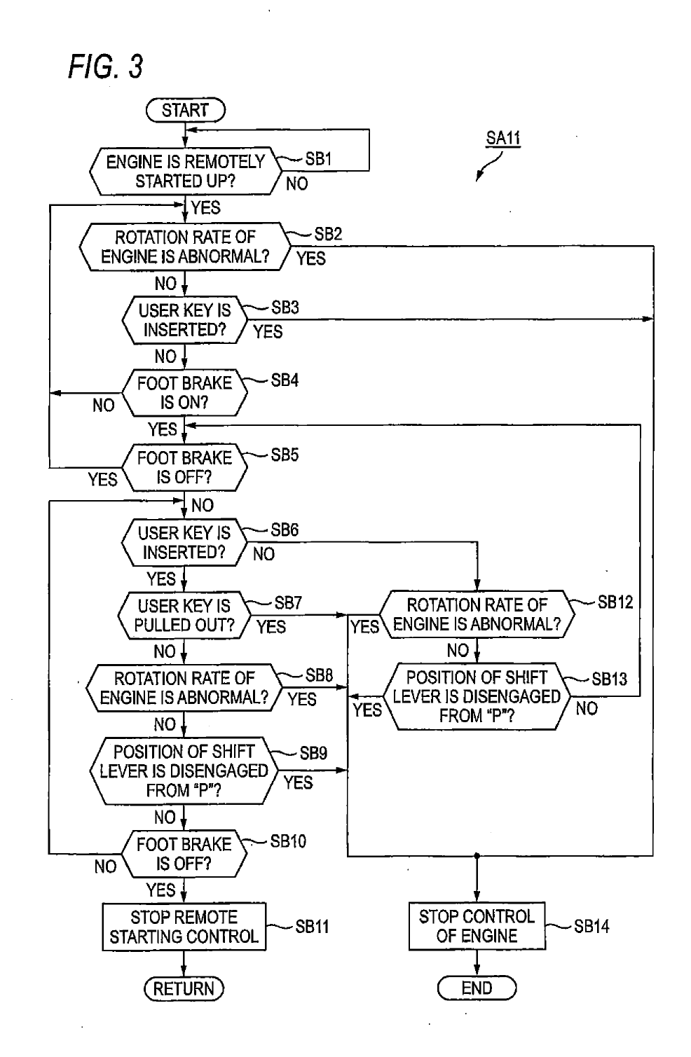

The details of the process of step SA11 in the main flow shown in FIG. 2 which is performed by the remote starting device 1 will be first described with reference to the sub flow shown in FIG. 3.

The remote starting device 1 of the vehicle control system SY1 determines whether the engine of the vehicle C is remotely started up (step SB1). That is, the remote starting device 1 determines whether engine is remotely started up by wirelessly receiving the signal instructing to start up the engine from the remote control terminal RC by the user's operation.

When it is determined that the engine of the vehicle C is remotely started up (YES in step SB1), the remote starting device 1 of the vehicle control system SY1 performs the process of step SB2.

The remote starting device 1 of the vehicle control system SY1 determines whether the rotation rate of the engine of the vehicle C is abnormal (step SB2). That is, the remote starting device 1 determines whether the number of rotations per second of the engine of the vehicle C, which is determined on the basis of the signal received from the crank pulse sensor 12, is equal to or greater than a predetermined rotation rate.

When it is determined that the engine of the vehicle C is not remotely started up (NO in step SB1), the remote starting device 1 of the vehicle control system SY1 repeats the process with a predetermined period.

When it is determined that the rotation rate of the engine is not abnormal (NO in step SB2), the remote starting device 1 performs the process of step SB3.

The remote starting device 1 of the vehicle control system SY1 determines whether the user key K is inserted into the key cylinder KS (step SB3). That is, the remote starting device 1 determines whether the user key K is inserted into the key cylinder KS on the basis of the signal received from the key insertion switch 6.

When it is determined that the rotation rate of the engine is abnormal (YES in step SB2), the remote starting device 1 performs the process of step SB14.

In step SB14, the remote starting device 1 of the vehicle control system SY1 performs the control of stopping the running of the engine of the vehicle C (step SB14). That is, the remote starting device 1 performs the remote starting control stopping procedure and transmits the signal for stopping the running of the engine to the engine controller 3. The engine controller 3 stops the running of the engine when receiving the signal for stopping the running of the engine.

When it is determined that the user key K is not inserted into the key cylinder KS (NO in step SB3), the remote starting device 1 performs the process of step SB4.

The remote starting device 1 of the vehicle control system SY1 determines whether the foot brake is pedaled (step SB4). That is, the remote starting device 1 determines whether the foot brake is changed from the OFF state to the ON state on the basis of the signal from the foot brake switch 7.

When it is determined that the user key K is inserted into the key cylinder KS (YES in step SB3), the remote starting device 1 performs the process of step SB14.

In step SB14, the remote starting device 1 of the vehicle control system SY1 performs the control of stopping the running of the engine of the vehicle C (step SB14).

When it is determined that the foot brake is pedaled (YES in step SB4), the remote starting device 1 performs the process of step SB5.

The remote starting device 1 of the vehicle control system SY1 determines whether the foot brake is changed from the pedaled state to the non-pedaled state (step SB5). That is, the remote starting device 1 determines whether the foot brake is changed from the ON state to the OFF state on the basis of the signal from the foot brake switch 7.

When it is determined that the foot brake is not pedaled (NO in step SB4), the remote starting device 1 performs the process of step SB2.

When it is determined that the foot brake is not changed from the pedaled state to the non-pedaled state by the user (NO in step SB5), the remote starting device 1 performs the process of step SB6.

The remote starting device 1 of the vehicle control system SY1 determines whether the user key K is inserted into the key cylinder KS (step SB6).

When it is determined that the foot brake is changed from the pedaled state to the non-pedaled state by the user (YES in step SB5), the remote starting device 1 performs the process of step SB2.

When it is determined that the user key K is inserted into the key cylinder KS (YES in step SB6), the remote starting device 1 performs the process of step SB7.

The remote starting device 1 of the vehicle control system SY1 determines whether the user key K is pulled out from the key cylinder KS (step SB7).

When it is determined that the user key K is not inserted into the key cylinder KS (NO in step SB6), the remote starting device 1 performs the process of step SB12.

When it is determined that the user key K is not pulled out from the key cylinder KS (NO in step SB7), the remote starting device 1 performs the process of step SB8.

The remote starting device 1 of the vehicle control system SY1 determines whether the rotation rate of the engine of the vehicle C is abnormal (step SB8).

When it is determined that the user key K is pulled out from the key cylinder KS (YES in step SB7), the remote starting device 1 performs the process of step SB14.

In step SB14, the remote starting device 1 of the vehicle control system SY1 performs the control of stopping the running of the engine of the vehicle C (step SB14).

When it is determined that the rotation rate of the engine is not abnormal (NO in step SB8), the remote starting device 1 performs the process of step SB9.

The remote starting device 1 of the vehicle control system SY1 determines whether the position of the shift lever of the vehicle C is disengaged from “P” (the perking position) (step SB9). That is, the remote starting device 1 determines whether the position of the shift lever of the vehicle C is disengaged from “P” on the basis of the signal received from the shift position sensor 11. When the position of the shift lever is disengaged from “P”, it means that the shift lever is located at “D”, “R”, “1”, “2”, “3”, and the like.

When it is determined that the rotation rate of the engine is abnormal (YES in step SB8), the remote starting device 1 performs the process of step SB14.

In step SB14, the remote starting device 1 of the vehicle control system SY1 performs the control of stopping the running of the engine of the vehicle C (step SB14).

When it is determined that the position of the shift lever is not disengaged from “P” (NO in step SB9), the remote starting device 1 performs the process of step SB10.

The remote starting device 1 of the vehicle control system SY1 determines whether the foot brake is changed from the pedaled state to the non-pedaled state (step SB10). That is, the remote starting device 1 determines whether the foot brake is changed from the ON state to the OFF state on the basis of the signal from the foot brake switch 7.

When it is determined that the position of the shift lever is disengaged from “P” (YES in step SB9), the remote starting device 1 performs the process of step SB14.

In step SB14, the remote starting device 1 of the vehicle control system SY1 performs the control of stopping the running of the engine of the vehicle C (step SB14).

When it is determined that the foot brake is changed from the pedaled state to the non-pedaled state by the user (YES in step SB10), the remote starting device 1 performs the process of step SB11.

The remote starting device 1 of the vehicle control system SY1 stops the control of remotely starting up the engine (step SB11). That is, the remote starting device 1 turns off the accessory switch ACC1 and the ignition switch IG1 thereof at the time of remotely starting up the engine.

When it is determined that the foot brake is not changed from the pedaled state to the non-pedaled state by the user (NO in step SB10), the remote starting device 1 performs the process of step SB6.

As described above, when the stopping of the brake pedaling operation is detected after the insertion of the user key K into the key cylinder KS and the foot brake pedaling operation are detected, the remote starting device 1 of the vehicle control system SY1 turns off the ignition switch IG1 of the remote starting device 1 which is a remote control switch. Accordingly, the running of the engine by the remote starting control is stopped but the engine is run under the control of the engine controller 3.

Accordingly, when the user performs the driving start operation after the user remotely starts up the engine of the vehicle C and then boards the vehicle C, the remote starting device 1 can disable stopping the running of the engine against the user's will.

The remote starting device 1 of the vehicle control system SY1 returns the procedure.

When the determination result of step SB6 is NO, that is, when it is determined that the user key K is not inserted, the remote starting device 1 of the vehicle control system SY1 determines whether the rotation rate of the engine is abnormal (step SB12). When it is determined that the rotation rate of the engine is abnormal (YES in step SB12), the remote starting device 1 performs the process of step SB14. When it is determined that the rotation rate of the engine is not abnormal (NO in step SB12), the remote starting device 1 performs the process of step SB13.

When the determination result of step SB12 is NO, that is, when it is determined that the rotation rate of the engine is not abnormal, the remote starting device 1 of the vehicle control system SY1 determines whether the position of the shift lever is disengaged from “P” (step SB13). When it is determined that the position of the shift lever is disengaged from “P” (YES in step SB13), the remote starting device 1 performs the process of step SB14. When it is determined that the position of the shift lever is not disengaged from “P” (NO in step SB13), the remote starting device 1 performs the process of step SB5.

In step SB14, the remote starting device 1 of the vehicle control system SY1 performs the control of stopping the running of the engine of the vehicle C (step SB14).

As described above, when the rotation rate of the engine is abnormal or when the position of the shift lever is disengaged from “P”, the remote starting device 1 of the vehicle control system SY1 stops the running of the engine, thereby enhancing the safety at the time of starting the driving of a vehicle.

### Second Embodiment

A second embodiment of the invention will be described below. Processes of the second embodiment different from the first embodiment will be mainly described below.

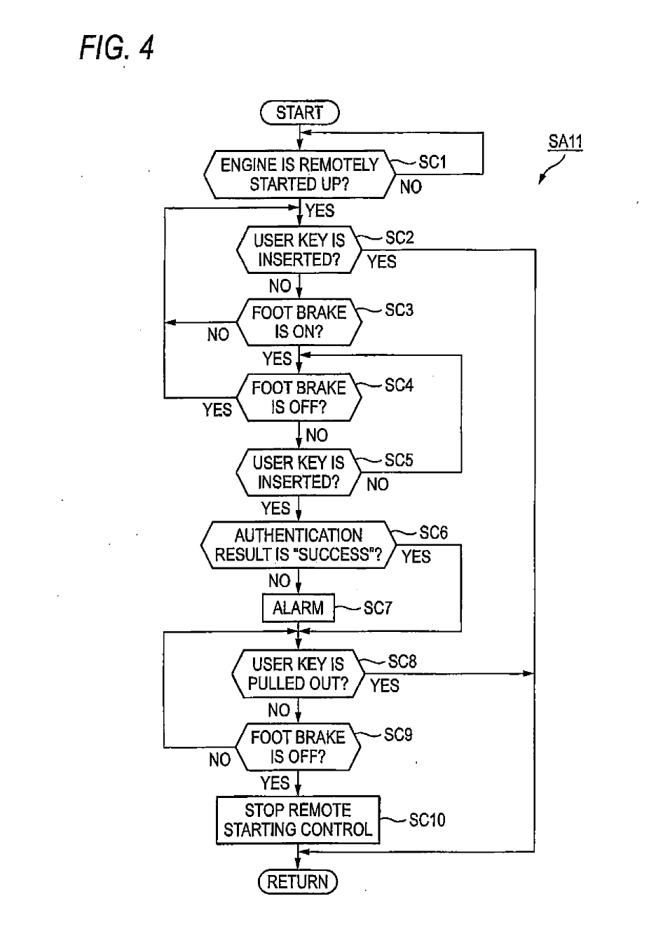

The process of step SA11, that is, the different process of the “remote starting control stopping procedure”, in the flow diagram shown in FIG. 2 and performed by the remote starting device 1 of the vehicle control system SY1 will be described with reference to the flow diagram shown in FIG. 4. The flow of procedure shown in FIG. 4 is performed when the vehicle control system SY1 performs the process of step ST11 in the flow diagram shown in FIG. 2.

(Sub Flow)

First, the remote starting device 1 of the vehicle control system SY1 determines whether the engine of the vehicle C is remotely started up (step SC1).

When it is determined that the engine of the vehicle C is remotely started up (YES in step SC1), the remote starting device 1 of the vehicle control system SY1 performs the process of step SC2.

The remote starting device 1 of the vehicle control system SY1 determines whether the user key K is inserted into the key cylinder KS (step SC2).

When it is determined that the engine of the vehicle C is not remotely started up (NO in step SC1), the remote starting device 1 of the vehicle control system SY1 repeats the process with a predetermined period.

When it is determined that the user key K is not inserted into the key cylinder KS (NO in step SC2), the remote starting device 1 performs the process of step SC3.

The remote starting device 1 of the vehicle control system SY1 determines whether the foot brake is pedaled (step SC3).

When it is determined that the user key K is inserted into the key cylinder KS (YES in step SC2), the remote starting device 1 returns the procedure.

When it is determined that the foot brake is pedaled (YES in step SC3), the remote starting device 1 performs the process of step SC4.

The remote starting device 1 of the vehicle control system SY1 determines whether the foot brake is changed from the pedaled state to the non-pedaled state (step SC4).

When it is determined that the foot brake is not pedaled (NO in step SC3), the remote starting device 1 performs the process of step SC2.

When it is determined that the foot brake is not changed from the pedaled state to the non-pedaled state by the user (NO in step SC4), the remote starting device 1 performs the process of step SC5.

The remote starting device 1 of the vehicle control system SY1 determines whether the user key K is inserted into the key cylinder KS (step SC5).

When it is determined that the foot brake is changed from the pedaled state to the non-pedaled state by the user (YES in step SC4), the remote starting device 1 performs the process of step SC2.

When it is determined that the user key K is inserted into the key cylinder KS (YES in step SC5), the remote starting device 1 performs the process of step SC6.

The authentication device 2 of the vehicle control system SY1 performs the above-mentioned authentication procedure. That is, the authentication device 2 receives the ID signal wirelessly transmitted from the user K via the transponder and performs the authentication process on the basis of the received ID signal when the user key K is inserted into the key cylinder KS. The authentication device 2 transmits the authentication result of the authentication procedure to the body controller 4 of the vehicle control system SY1.

The body controller 4 of the vehicle control system SY1 determines whether the authentication result received from the authentication device 2 is “success” (step SC6).

When it is determined that the user key K is not inserted into the key cylinder KS (NO in step SC5), the remote starting device 1 performs the process of step SC4.

When it is determined that the received authentication result is not “success” (NO in step SC6), the body controller 4 performs the process of step SC7.

When it is determined that the received authentication result is not “success”, the body controller 4 performs an alerting process (step SC7). The alerting process means a process of controlling the hazard lamp 16 or the buzzer 18 to inform outside the vehicle C of the fact that, because the authentication result received by the body controller 4 is not “success”, the vehicle C has been stolen using a counterfeit user key of a non-authentic user.

When it is determined that the received authentication result is “success” (YES in step SC6), the body controller 4 performs the process of step SC8.

The remote starting device 1 of the vehicle control system SY1 determines whether the user key K is pulled out from the key cylinder KS (step SC8).

When it is determined that the user key K is not pulled out from the key cylinder KS (NO in step SC8), the remote starting device 1 performs the process of step SC9.

The remote starting device 1 of the vehicle control system SY1 determines whether the foot brake is changed from the pedaled state to the non-pedaled state (step SC9). That is, the remote starting device 1 determines whether the foot brake is changed from the ON state to the OFF state on the basis of the signal from the foot brake switch 7.

When it is determined that the user key K is pulled out from the key cylinder KS (YES in step SC8), the remote starting device 1 returns the procedure.

When it is determined that the foot brake is changed from the pedaled state to the non-pedaled state by the user (YES in step SC9), the remote starting device 1 performs the process of step SC10.

The remote starting device 1 of the vehicle control system SY1 stops the control of remotely starting up the engine (step SC10). That is, the remote starting device 1 turns off the accessory switch ACC1 and the ignition switch IG1 thereof at the time of remotely starting up the engine.

When it is determined that the foot brake is not changed from the pedaled state to the non-pedaled state by the user (NO in step SC9), the remote starting device 1 performs the process of step SC8.

The remote starting device 1 of the vehicle control system SY1 returns the procedure.

As described above, when the stopping of the foot brake pedaling operation is detected after the insertion of the user key K into the key cylinder KS and the foot brake pedaling operation are detected, the remote starting device 1 of the vehicle control system SY1 turns off the ignition switch IG1 of the remote starting device 1 which is a remote control switch. Accordingly, the running of the engine by the remote starting control is stopped but the engine is run under the control of the engine controller 3.

Accordingly, when the user performs the driving start operation after the user remotely starts up the engine of the vehicle C and then boards the vehicle C, the remote starting device 1 can disable stopping the running of the engine against the user's will.

According to the above-mentioned control procedure, the vehicle control system SY1 can enable driving the vehicle C even when the authentication result in the authentication device 2 is not “success”. Accordingly, the vehicle C may be temporarily stolen by a non-authentic user. However, in this case, the running of the engine is not stopped by the engine controller 3.

This is because the authentication procedure performed by the authentication device 2 of the vehicle control system SY1 takes a predetermined time (for example, 10 seconds) until the authentication result is obtained. The vehicle C may travel in the meantime. In this case, when the running of the engine is stopped by the engine controller 3, the vehicle C may be subjected to a traffic accident.

Therefore, when the vehicle C is in the driving-enabled state and the authentication result is not “success”, the vehicle control system SY1 performs the alerting process to inform outside the vehicle C of the possibility of the theft of the vehicle C, thereby preventing the theft of the vehicle C.

### Third Embodiment

A third embodiment of the invention will be described below. Processes of the third embodiment different from the first embodiment will be mainly described below.

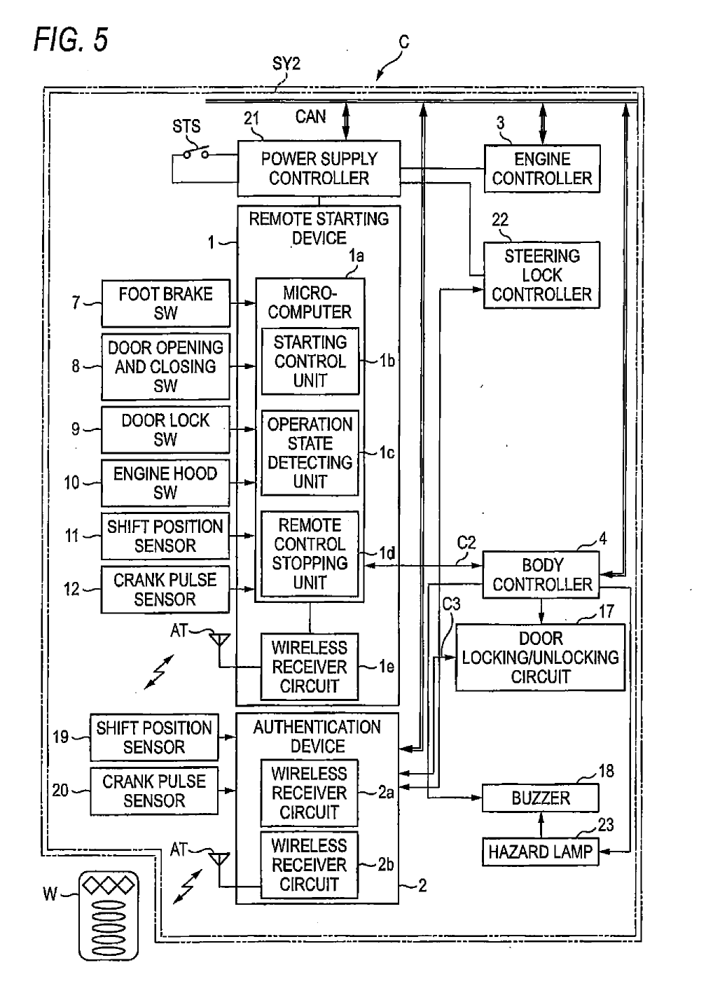

The third embodiment is different from the first embodiment in a partial configuration of the vehicle control system. Although it has been described in the first embodiment that “The vehicle control system SY1 includes the key cylinder KS. The key cylinder KS includes the accessory switch ACC, the ignition switch IG, and the starter switch ST. The vehicle control system SY1 includes the remote starting device 1. The remote starting device 1 includes the accessory switch ACC1, the ignition switch IG1, and the starter switch ST1”, a vehicle control system SY2 according to the third embodiment does not have such a configuration, as shown in FIG. 5.

Instead, the vehicle control system SY2 includes a push-type starting system that starts up the engine of the vehicle C. As shown in FIG. 5, the push-type starting system includes a starter switch STS as a power supply switch, a power supply controller 21, an authentication device 2, a wireless key W, and a body controller 4.

That is, when a user operates the wireless key W on the vehicle C and boards the vehicle C, the authentication result in the authentication device 2 is “success”. Accordingly, the push-type starting system performs an operation of accepting a driving start thereafter as a simple operation. That is, the user can drive the vehicle C by pushing the starter switch STS thereafter.

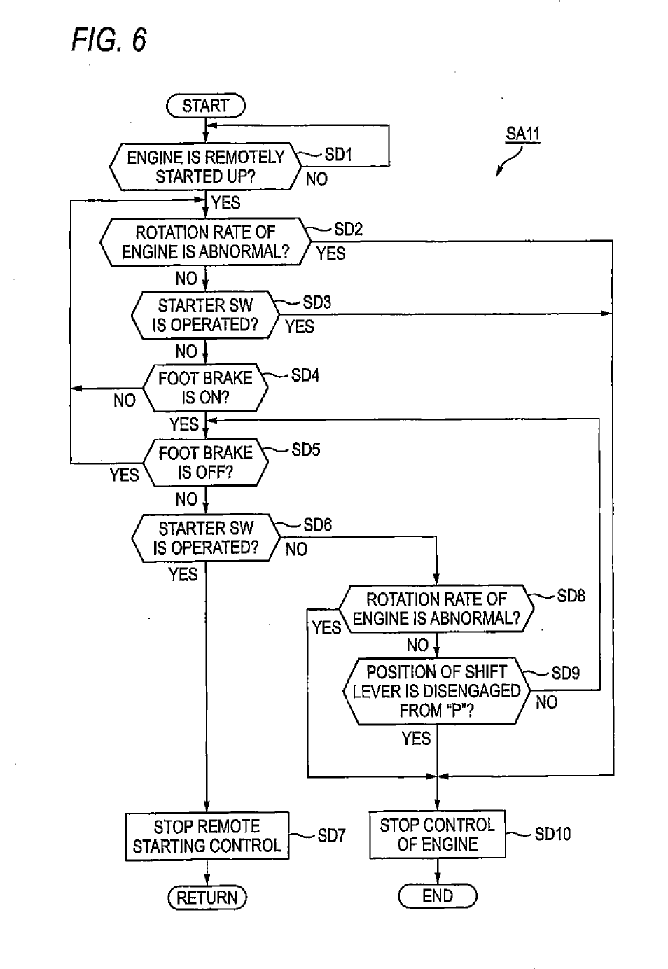

The process of step SA11, that is, the different process of the “remote starting control stopping procedure”, in the flow diagram shown in FIG. 2 and performed by the vehicle control system SY2 having the push-type starting system will be described with reference to the sub flow diagram shown in FIG. 6.

The vehicle control system SY2 performs the procedure shown in the sub flow diagram of FIG. 6, when performing the “remote starting control stopping procedure” of step SA11 in the procedure shown in the flow diagram of FIG. 2.

(Sub Flow)

First, the details of the procedure of step SA11 shown in the main flow diagram of FIG. 2 and performed by the remote starting device 1 will be described with reference to the sub flow diagram of FIG. 6.

The remote starting device 1 of the vehicle control system SY2 determines whether the engine of the vehicle C is remotely started up (step SD1).

When it is determined that the engine of the vehicle C is remotely started up (YES in step SD1), the remote starting device 1 of the vehicle control system SY2 performs the process of step SD2.

The remote starting device 1 of the vehicle control system SY2 determines whether the rotation rate of the engine of the vehicle C is abnormal (step SD2).

When it is determined that the engine of the vehicle C is not remotely started up (NO in step SD1), the remote starting device 1 of the vehicle control system SY2 repeats the process with a predetermined period.

When it is determined that the rotation rate of the engine is abnormal (YES in step SD2), the remote starting device 1 performs the process of step SD10. When it is not determined that the rotation rate of the engine is not abnormal (NO in step SD2), the remote starting device 1 performs the process of step SD3.

The remote starting device 1 of the vehicle control system SY2 determines whether the starter switch STS is turned on (step SD3). That is, the remote starting device 1 determines whether the signal representing the turning-on of the starter switch STS is received from the power supply controller 21 having detected the turning-on of the starter switch STS.

When it is determined that the starter switch STS is not turned on (NO in step SD3), the remote starting device 1 performs the process of step SD4.

The remote starting device 1 of the vehicle control system SY2 determines whether the foot brake is pedaled (step SD4).

When it is determined that the starter switch STS is turned on (YES in step SD3), the remote starting device 1 performs the process of step SD10.

In step SD10, the remote starting device 1 of the vehicle control system SY2 performs the control of stopping the running of the engine of the vehicle C (step SD10). That is, the remote starting device 1 transmits the signal for stopping the running of the engine to the engine controller 3. The engine controller 3 stops the running of the engine when receiving the signal for stopping the running of the engine.

In step SD10, the remote starting device 1 of the vehicle control system SY2 performs the control of stopping the running of the engine of the vehicle C (step SD10).

When it is determined that the foot brake is pedaled (YES in step SD4), the remote starting device 1 performs the process of step SD5.

The remote starting device 1 of the vehicle control system SY2 determines whether the foot brake is changed from the pedaled state to the non-pedaled state (step SD5).

When it is determined that the foot brake is not pedaled (NO in step SD4), the remote starting device 1 performs the process of step SD2.

When it is determined that the foot brake is changed from the pedaled state to the non-pedaled state by the user (YES in step SD5), the remote starting device 1 performs the process of step SD6.

The remote starting device 1 of the vehicle control system SY2 determines whether the starter switch STS is turned on (step SD6).

When it is determined that the foot brake is not changed from the pedaled state to the non-pedaled state by the user (NO in step SD5), the remote starting device 1 performs the process of step SD2.

When it is determined that the starter switch STS is turned on (YES in step SD6), the remote starting device 1 performs the process of step SD7.

The remote starting device 1 of the vehicle control system SY2 stops the control of remotely starting up the engine (step SD7). That is, the remote starting device 1 turns off the accessory switch ACC1 and the ignition switch IG1 thereof at the time of remotely starting up the engine.

When it is determined that the starter switch STS is not turned on (NO in step SD6), the remote starting device 1 performs the process of step SD8.

As described above, when the operation of the starter switch STS is detected after the brake pedaling operation is detected, the remote starting device 1 of the vehicle control system SY2 turns off the ignition switch IG1 of the remote starting device 1 which is a remote control switch. Accordingly, the running of the engine by the remote starting control is stopped but the engine is run under the control of the engine controller 3.

Accordingly, when the user performs the driving start operation after the user remotely starts up the engine of the vehicle C and then boards the vehicle C, the remote starting device 1 can disable stopping the running of the engine against the user's will.

The remote starting device 1 of the vehicle control system SY2 returns the procedure.

When the determination result of step SD6 is NO, that is, when it is determined that the starter switch STS is not turned on, the remote starting device 1 of the vehicle control system SY2 determines whether the rotation rate of the engine is abnormal (step SD8). When it is determined that the rotation rate of the engine is abnormal (YES in step SD8), the remote starting device 1 performs the process of step SD10. When it is determined that the rotation rate of the engine is not abnormal (NO in step SD8), the remote starting device 1 performs the process of step SD9.

When the determination result of step SD8 is NO, that is, when it is determined that the rotation rate of the engine is not abnormal, the remote starting device 1 of the vehicle control system SY2 determines whether the position of the shift lever is disengaged from “P” (step SD9). When it is determined that the position of the shift lever is disengaged from “P” (YES in step SD8), the remote starting device 1 performs the process of step SD10. When it is determined that the position of the shift lever is not disengaged from “P” (NO in step SD9), the remote starting device 1 performs the process of step SDS.

In step SD10, the remote starting device 1 of the vehicle control system SY2 performs the control of stopping the running of the engine of the vehicle C (step SD10).

As described above, when the rotation rate of the engine is abnormal or when the position of the shift lever is disengaged from “P”, the remote starting device 1 of the vehicle control system SY2 stops the running of the engine, thereby enhancing safety at the time of starting the driving of a vehicle.

### Fourth Embodiment

A fourth embodiment of the invention will be described below. The fourth embodiment includes control processes equal to and different from the control processes in the vehicle control system SY2 described in the third embodiment.

Therefore, the control processes different from the control processes in the vehicle control system SY2 described in the third embodiment will be mainly described in the fourth embodiment.

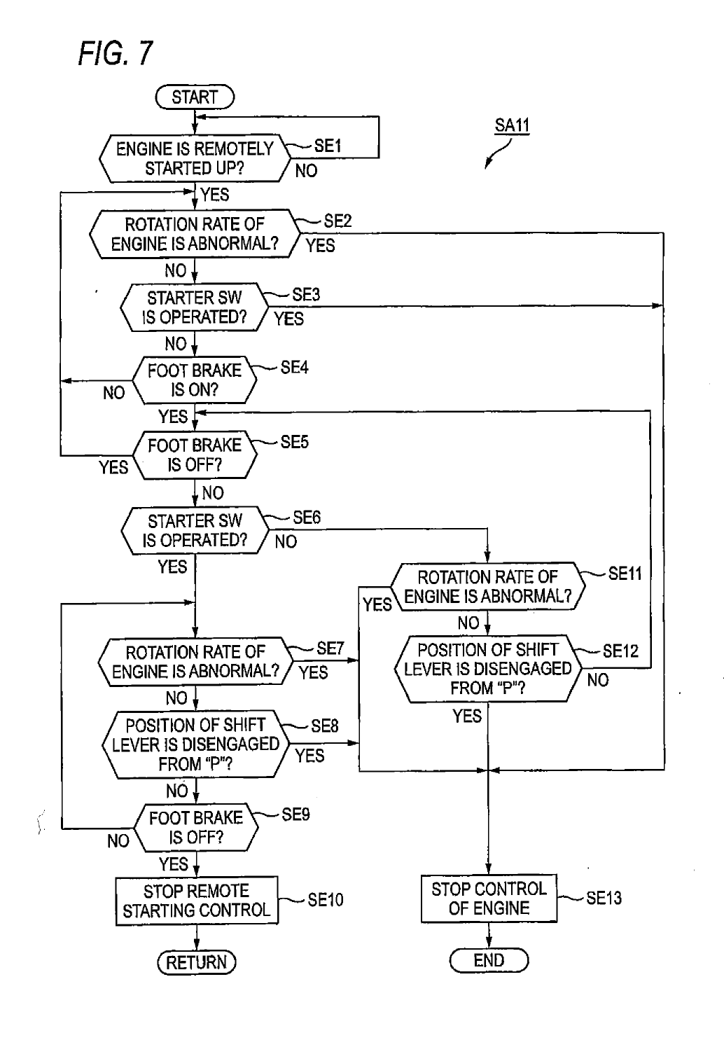

The control processes performed by the vehicle control system SY2 in the fourth embodiment further include new processes between step SD6 and step SD7 in FIG. 6 which is the flow diagram according to the third embodiment, as shown in the flow diagram of FIG. 7.

The new processes will be mainly described in detail below.

(Sub Flow)

First, the remote starting device 1 of the vehicle control system SY2 determines whether the engine of the vehicle C is remotely started up. The remote starting device 1 determines whether the foot brake is pedaled before the starter switch STS is operated. Thereafter, the remote starting device 1 determines whether the starter switch STS is operated (steps SE1 to SE6).

The remote starting device 1 of the vehicle control system SY2 determines whether the rotation rate of the engine of the vehicle C is abnormal (step SE7).

When it is determined that the rotation rate of the engine is not abnormal (NO in step SE7), the remote starting device 1 performs the process of step SE8.

The remote starting device 1 of the vehicle control system SY2 determines whether the position of the shift lever of the vehicle C is disengaged from “P” (step SE8).

When it is determined that the rotation rate of the engine is abnormal (YES in step SE7), the remote starting device 1 performs the process of step SE13.

In step SE13, the remote starting device 1 of the vehicle control system SY2 performs the control of stopping the running of the engine of the vehicle C (step SE13). That is, the remote starting device 1 transmits the signal for stopping the running of the engine to the engine controller 3. The engine controller 3 stops the running of the engine when receiving the signal for stopping the running of the engine.

When it is determined that the position of the shift lever of the vehicle C is not disengaged from “P” (NO in step SE8), the remote starting device 1 performs the process of step SE9.

The remote starting device 1 of the vehicle control system SY2 determines whether the foot brake is changed from the pedaled state to the non-pedaled state (step SE9).

When it is determined that the position of the shift lever of the vehicle C is disengaged from “P” (YES in step SE 8), the remote starting device 1 performs the process of step SE13.

In step SE13, the remote starting device 1 of the vehicle control system SY2 performs the control of stopping the running of the engine of the vehicle C (step SE13).

When it is determined that the foot brake is changed from the pedaled state to the non-pedaled state by the user (YES in step SE9), the remote starting device 1 performs the process of step SE10.

The remote starting device 1 of the vehicle control system SY2 stops the control of remotely starting up the engine (step SE10). That is, the remote starting device 1 turns off the accessory switch ACC1 and the ignition switch IG1 thereof at the time of remotely starting up the engine.

When it is determined that the foot brake is not changed from the pedaled state to the non-pedaled state by the user (NO in step SE9), the remote starting device 1 performs the process of step SE7.

The remote starting device 1 of the vehicle control system SY2 returns the procedure.

As described above, when the pedaling of the foot brake is detected again after the pedaling of the foot brake is detected and then the operation of the starter switch STS is detected, the remote starting device 1 of the vehicle control system SY2 turns off the ignition switch IG1 of the remote starting device 1 which is a remote control switch. Accordingly, the running of the engine by the remote starting control is stopped but the engine is run under the control of the engine controller 3.

Accordingly, when the user performs the driving start operation after the user remotely starts up the engine of the vehicle C and then boards the vehicle C, the remote starting device 1 can disable stopping the running of the engine against the user's will.

As described above, when the rotation rate of the engine is abnormal or when the position of the shift lever is disengaged from “P”, the remote starting device 1 of the vehicle control system SY2 stops the miming of the engine, thereby enhancing safety at the time of starting the driving of a vehicle.

### Fifth Embodiment

A fifth embodiment of the invention will be described below. The fifth embodiment includes control processes equal to and different from the control processes in the vehicle control system SY2 described in the third embodiment.

Therefore, the control processes different from the control processes in the vehicle control system SY2 described in the third embodiment will be mainly described in the fifth embodiment.

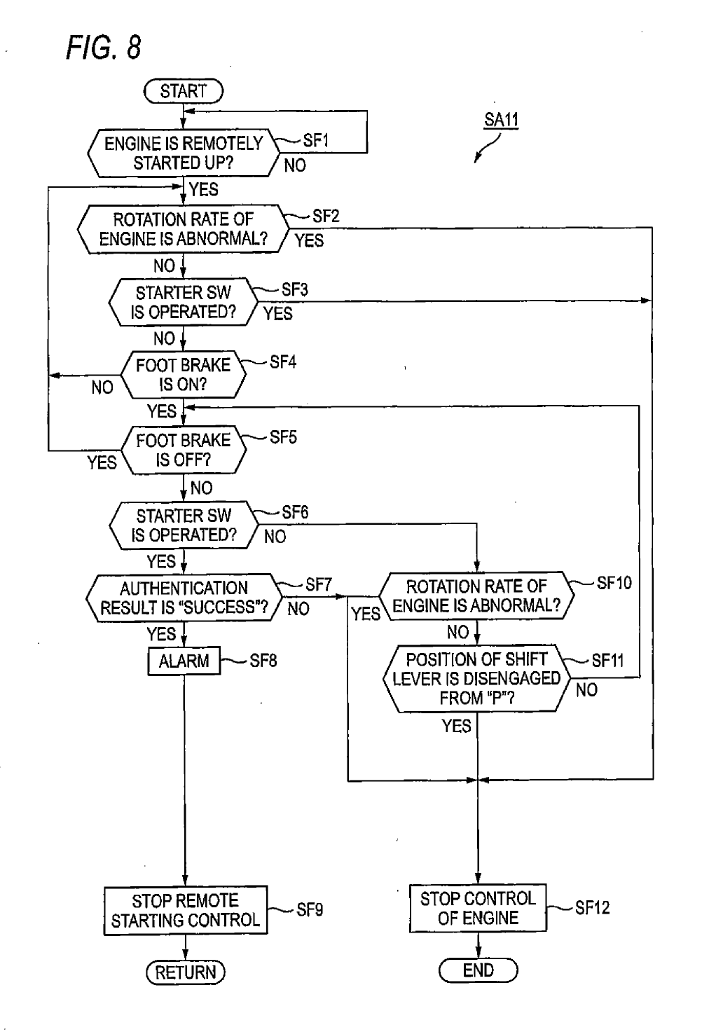

The control processes performed by the vehicle control system SY2 in the fifth embodiment further include new processes between step SD6 and step SD7 in FIG. 6 which is the flow diagram according to the third embodiment, as shown in the flow diagram of FIG. 8.

The new processes will be mainly described in detail below.

(Sub Flow)

First, the remote starting device 1 of the vehicle control system SY2 determines whether the engine of the vehicle C is remotely started up. The remote starting device 1 determines whether the foot brake is pedaled before the starter switch STS is operated. Thereafter, the remote starting device 1 determines whether the starter switch STS is operated (steps SF1 to SF6).

When the starter switch STS is operated by the user, the authentication device 2 of the vehicle control system SY2 performs the authentication procedure on the basis of the ID signal received from the wireless key W in advance. The authentication device 2 transmits the authentication result of the authentication procedure to the body controller 4.

The body controller 4 of the vehicle control system SY2 determines whether the authentication result received from the authentication device 2 is “success” (step SF7).

When it is determined that the received authentication result is “success” (YES in step SF7), the body controller 4 performs the process of step SF8.

The body controller 4 performs the above-mentioned alerting process (step SC8).

When it is determined that the received authentication result is not “success” (NO in step SF7), the body controller 4 performs the process of step SF12.

In step SF12, the remote starting device 1 of the vehicle control system SY2 performs the control of stopping the running of the engine of the vehicle C (step SF12). That is, the remote starting device 1 transmits the signal for stopping the running of the engine to the engine controller 3. The engine controller 3 stops the running of the engine when receiving the signal for stopping the running of the engine.

The remote starting device 1 of the vehicle control system SY2 stops the control of remotely starting up the engine (step SF9). That is, the remote starting device 1 turns off the accessory switch ACC1 and the ignition switch IG1 thereof at the time of remotely starting up the engine.

The remote starting device 1 of the vehicle control system SY2 returns the procedure.

As described above, when the operation of the starter switch STS and the pedaling of the foot brake are detected, the remote starting device 1 of the vehicle control system SY2 turns off the ignition switch IG1 of the remote starting device 1 which is a remote control switch. Accordingly, the running of the engine by the remote starting control is stopped but the engine is run under the control of the engine controller 3.

Accordingly, when the user performs the driving start operation after the user remotely starts up the engine of the vehicle C and then boards the vehicle C, the remote starting device 1 can disable stopping the running of the engine against the user's will.

According to the above-mentioned control procedure, the vehicle control system SY2 can enable driving the vehicle C even when the authentication result in the authentication device 2 is not “success”. Accordingly, the vehicle C may be temporarily stolen by a non-authentic user. However, in this case, the running of the engine is not stopped by the engine controller 3.

This is because the authentication procedure performed by the authentication device 2 of the vehicle control system SY2 takes a predetermined time (for example, 10 seconds) until the authentication result is obtained. The vehicle C may travel in the meantime. In this case, when the running of the engine is stopped by the engine controller 3, the vehicle C may be subjected to a traffic accident.

Therefore, when the vehicle C is in the driving-enabled state and the authentication result is not “success”, the vehicle control system SY2 performs the alerting process to inform outside the vehicle C of the possibility of the theft of the vehicle C, thereby preventing the theft of the vehicle C.

### MODIFIED EXAMPLES

Although the first to fifth embodiments of the invention have been described, the invention is not limited to the first to fifth embodiments and can be modified in various forms. Modified examples will be described below. The modified examples to be described below may be properly combined.

### Modified Example 1

In the first and second embodiments, it has been described that the remote starting device 1 of the vehicle control system SY1 stops the remote starting control when the user key K is inserted into the key cylinder KS and the pedaling of the foot brake is stopped after the foot brake is pedaled.

However, the vehicle control system SY1 may stop the remote starting control when the foot brake is pedaled and the pedaling of the foot brake is stopped after the engine is started up by the remote starting device 1 of the vehicle control system SY1 and the user key K is inserted into the key cylinder KS.

When the remote starting device 1 of the vehicle control system SY1 performs the control in this order, it is possible to obtain the same advantages as described in the first and second embodiments.

### Modified Example 2

Although the authentication procedure in the first and second embodiments has been described as taking place “When the user inserts the user key K into the key insertion hole, the transponder 5 wirelessly receives the ID signal from the user key K. The transponder 5 transmits the received ID signal to the authentication device 2. The authentication device 2 determines whether the received ID signal is matched with the ID signal stored in advance, and transmits the signal representing “success” as the authentication result to the body controller and the engine controller 3 when both are matched with each other.”, the authentication procedure may be carried out on the basis of a signal received from a smart key.

For example, when a user carrying a smart key is located in the vicinity of the vehicle C, the smart key transmits the ID signal to the transponder 5 of the vehicle C regardless of the user's operation. The transponder 5 wirelessly receives the ID signal from the smart key. The transponder 5 transmits the received ID signal to the authentication device 2. The authentication device 2 determines whether the received ID signal is matched with the ID signal stored in advance, and transmits the signal representing “success” as the authentication result to the body controller and the engine controller 3 when both are matched with each other. The body controller 4 unlocks the door of the vehicle. The engine controller 3 allows the running of the engine.

### Modified Example 3

Although it has been described in the first and second embodiments that various functions are embodied in software through the calculation procedure of the controller based on the program, some of the functions may be embodied in electrical hardware circuits. On the contrary, some of the functions described as embodied in the hardware circuits may be embodied in software.

### Modified Example 4

In the first to fifth embodiments, the flow diagram illustrating the control procedure of the vehicle control system is described as a single flow for the purpose of convenience. However, the controller may perform flows, into which the single flow is divided, in parallel by a multi-tasking function.

### Sixth Embodiment

Hereinafter, a remote starting device according to a sixth embodiment of the invention, that is mounted on a vehicle having an automatic transmission and that remotely starts up an engine on the basis of an operation of a remote control terminal will be described.

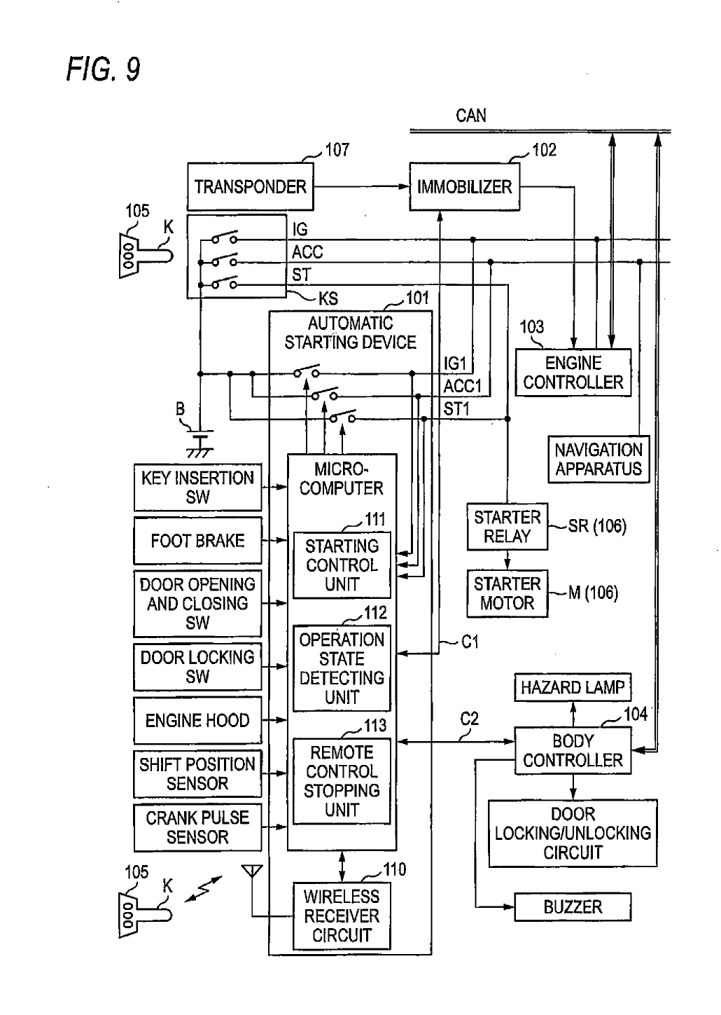

FIG. 9 shows a primary control system of a vehicle including a remote starting device 101. The vehicle includes electronic controllers such as a remote starting device 101, an immobilizer 102, an engine controller 103, and a body controller 104 and a key cylinder KS controlling switches that supply power to the loads of the vehicle from a battery B.

Each electronic controller includes a microcomputer having a CPU, a ROM storing a control program executed by the CPU, and a RAM storing control data or calculation data. The electronic controllers such as the engine controller 103 and the body controller 104 are connected to each other so as to transmit and receive data via a vehicle network CAN (Controller Area Network).

In the vehicle, when an operator inserts an ignition key (hereinafter, simply referred to as “key”) K into the key cylinder KS and turns the key K, an accessory power switch ACC disposed in a power supply path for supplying power to accessory devices from a battery B is turned on, an ignition switch IG disposed in a power supply path for supplying power to ignition devices from the battery B is turned on, and a starter switch ST disposed in a power supply path for supplying power to a starter circuit 106 from the battery B is turned on. The key cylinder KS is provided with a contact circuit so as to turn on the ignition switch IG and to turn off the accessory switch ACC at the time of turning on the starter switch ST.

The accessory devices include loads such as a navigation device, an audio device, and an air cleaner and the ignition devices include loads such as an ignition circuit, an engine controller, and an air conditioner.

The starter circuit 106 includes a starter motor M which cranks the engine and a starter relay SR applying a voltage of the battery B to the starter motor M.

In the sixth embodiment, a key K having an electronic chip storing a specific ID code built in a key head and including a door locking switch, a door unlocking switch, and an engine starting switch is used as a remote control terminal 105.

The immobilizer 102 receives the ID code stored in the electronic chip built in the key K via a transponder 107, electronically verifies the received ID code with a vehicle ID code, and transmits a control signal representing that it is an authentic key to the engine controller 103 when both codes are equal to each other.

The engine controller 103 is connected to a power supply line via the accessory switch ACC and a power supply line via the ignition switch IG and detects states of the switches on the basis of voltages of the power supply lines.

The engine controller 103 starts when the ignition switch IG is turned on and starts up the engine only when receiving the control signal representing that it is an authentic key from the immobilizer 102. That is, when the starter switch ST is turned on to crank the engine, the engine controller 103 determines a steam cylinder on the basis of a crank pulse output from a crank sensor disposed in a crankshaft, injects fuel to the steam cylinders at a predetermined time, starts up the engine by controlling the ignition, and stops the engine by stopping the fuel injection and the ignition control when the ignition switch IG is turned off.

The body controller 104 controls an automatic door locking and unlocking circuit in response to operations of the door locking switch and the door unlocking switch disposed in the key K and controls the buzzing of a buzzer when an intruder is detected.

The remote starting device 101 includes three relay circuits ACC1, IG1, and ST1 connecting the battery B to the accessory devices, the ignition devices, and the starter circuit, respectively, independently of the switches such as the accessory switch ACC, the ignition switch IG, and the starter switch ST. The output voltages of the relay circuits ACC1, IG1, and ST1 are input as monitoring signals of the relay circuits ACC1, IG1, and ST1 to the remote starting device 101. The relay circuit IG1 serves as the remote control switch in the invention.

The remote starting device 101 includes a wireless receiver circuit 110 that receives remote control signals such as an engine starting signal, a door locking signal, and a door unlocking signal wirelessly transmitted from the remote control terminal 105.

The remote starting device 101, the immobilizer 102, and the body controller 104 are connected to each other via local communication lines C1 and C2. The remote starting device 101 reads an ID code for combination from the immobilizer 102, combines the ID with that of the remote control terminal 105, transmits the combination result to the immobilizer 102, and transmits the door unlocking signal or the door locking signal transmitted from the remote control terminal 105 to the body controller 104 when it is an authentic remote control terminal 105.

Switch signals such as an insertion switch signal of the key K into the key cylinder KS where the insertion switch is disposed in the key cylinder, which is control data necessary for the remote starting control of the engine, a brake pedaling signal, a door opening and closing switch signal, a door locking and unlocking switch signal, an engine hood signal, a shift position switch signal, and an engine rotation rate signal are input to the remote starting device 101.

The remote starting device 101 includes functional blocks such as a starting control unit 111 that starts up the engine when receiving the engine starting signal wirelessly transmitted from the remote control terminal 105, an operation state detecting unit 112 that detects at least the insertion of the key K into the key cylinder KS and the brake pedaling operation by the operator on the basis of the input of the above-mentioned switch signals, and a remote control stopping unit 113 that determines that the ignition switch IG is turned on by the operation of the key K when the insertion of the key K is detected before or after the brake pedaling operation is detected by the operation state detecting unit 112 after the engine is started up by the starting control unit 111 and that turns off the relay circuits ACC1 and IG1.

The functional blocks are embodied by a control program stored in the ROM and the CPU executing the control program.

The starting control unit 111 receives the ID and the engine starting signal wirelessly transmitted from the remote control terminal 105, transmits a signal representing that it is an authentic ID to the immobilizer 102 when it is authenticated that it is an authentic ID, and turns on the remote-starting relay circuits ACC1, IG1, and ST1.

The engine controller 103 starts up the engine by receiving a signal representing that the engine starting signal has been received from the authentic remote control terminal 105 from the immobilizer 102, identifying the cylinders on the basis of the crank pulse when the cranking of the engine is confirmed, injecting fuel to the cylinders at a predetermined time, and controlling the ignition.

At this time, when a switch of an air conditioner connected to a power supply path via the ignition switch IG is turned on, the air-conditioning of the vehicle interior is simultaneously started.

The starting control unit 111 turns on the relay circuit ST1, then detects the crank pulse which is the engine rotation rate signal, and determines that the starting of the engine is finished when the engine reaches a predetermined rotation rate, and turns off the relay circuit ST1.

Thereafter, the remote control stopping unit 113 continues to perform a warming-up operation for a predetermined time, for example, about 20 minutes, turns off the relay circuits ACC1 and IG1 when the predetermined time passes, and stops the engine. When the engine starting switch built in the remote control terminal 105 is turned on again during the warming-up operation, the engine stopping signal is transmitted. When the engine stopping signal is received, the engine is stopped.

At the time of continuing to perform the warming-up operation for about 20 minutes, the remote control stopping unit 113 performs one of a control procedure of ending the remote starting control operation to enter a driving-enabled state without stopping the engine in the state where the engine is remotely started up and a control procedure of stopping the engine to prevent the theft of the vehicle by a third party on the basis of the operator's operation detected by the operation state detecting unit.

In general, in a vehicle having an automatic transmission, an operator inserts and turns a key, then pedals the brake, and switches the shift lever from the parking range to the driving range to enter a driving-enabled state.

Accordingly, by entering the driving-enabled state without stopping the engine only when the key K is inserted into the key cylinder KS and the turning-on of the ignition switch IG due the operation of the key K is detected in the state where the engine is remotely started up, it is possible to improve the convenience to the operator.

However, in order to detect the turning-on of the ignition switch IG due to the operation of the key K, it is necessary to provide a dedicated detector circuit, thereby causing an increase in cost of the vehicle.

An operator may operate the key after pedaling the brake. In this case, when the remote control stopping unit 113 determines that it is an abnormal operation procedure and stops the engine, an authentic operator such as an owner of the vehicle needs to operate the key again to restart the engine.

Therefore, the remote starting device 101 according to the sixth embodiment of the invention can determine the key operation without providing a detector circuit detecting the turning-on of the ignition switch IG due to the operation of the key K and can enter a driving-enabled state without stopping the engine even when the brake pedaling operation is performed before the key operation.

Specifically, the remote control stopping unit 113 determines that the ignition switch IG is turned on due to the operation of the key K and turns off the relay circuits ACC1 and IG1, when the insertion of the key K is detected by the operation state detecting unit after the engine is started up by the starting control unit.

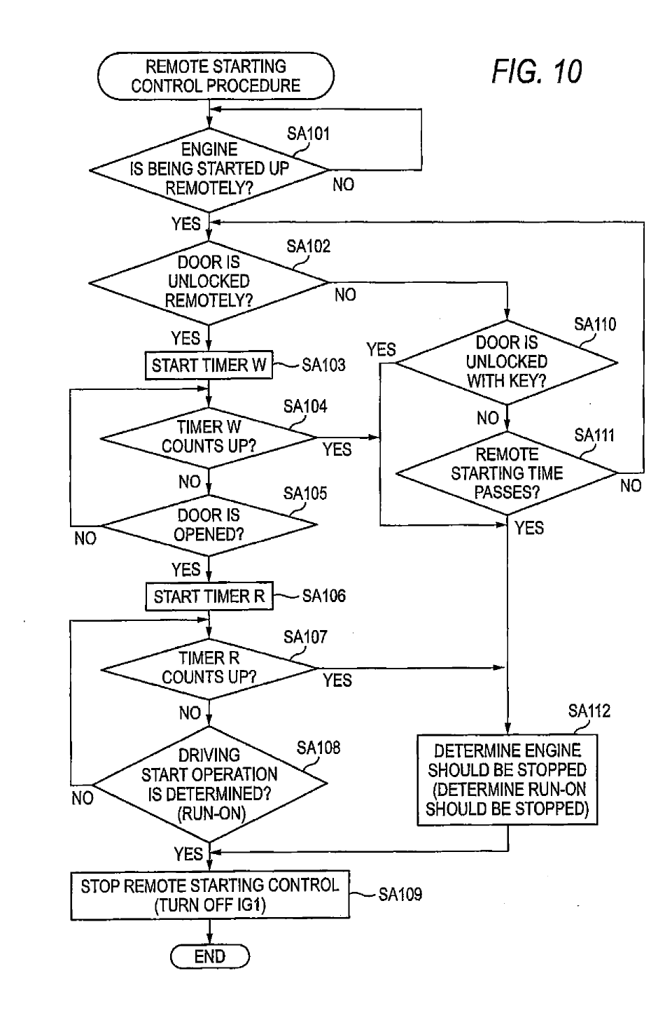

Details thereof will be described below. As shown in FIG. 10, when the operation state detecting unit 112 detects that a door is unlocked by the remote control terminal 105 (SA102) in the state (SA101) where the engine is remotely started up by the starting control unit 111 having received the engine starting signal from the remote control terminal 105, the remote control stopping unit 113 determines that it is an authentic operator and starts a timer W (SA103).

The timer W is a timer defining a delay time until a subsequent operation, that is, the opening or closing of a door, is detected and is used to forcibly stop the engine for the purpose of prevention of theft when the opening or closing of a door is not detected within the delay time. The value of the timer is set to, for example, about 10 seconds, but is not limited thereto.

When the timer W counts up (SA104), the remote control stopping unit 113 determines whether to stop the engine (SA112) and stops the remote starting control procedure, that is, bans a run-on operation enabling driving in the remotely-started state of the engine to turn off the relay circuit IG1 at once. Accordingly, the engine is stopped (SA109).

When the operation state detecting unit 112 detects that the door of a driver's seat is opened (SA105) until the timer W counts up (SA104), the remote control stopping unit 113 starts a timer R (SA106).

The timer R is a timer defining a delay time until the operator boards the vehicle and performs a driving start operation such as the insertion of the key K and the brake pedaling operation, and is used to forcibly stop the engine for the purpose of prevention of theft when the driving start operation is not detected within the delay time. The value of the timer is set to, for example, about 10 seconds, but is not limited thereto.

When the timer R counts up (SA107), the remote control stopping unit 113 determines whether to stop the engine (SA112) and stops the remote starting control procedure, that is, turns off the relay circuit IG1. Accordingly, the engine is stopped (SA109).

When the operation state detecting unit 112 detects the driving start operation (which is an operation for starting the driving such as operating the key K and operating the brake and is also referred to as “run-on operation”) (SA108) until the timer R counts up (SA107), the remote control stopping unit 113 determines that the ignition switch IG is turned on by the key K to enter the driving-enabled state, and stops the remote starting control procedure, that is, turns off the relay circuit IG1 (SA109). At this time, since the ignition switch IG is turned on, it is possible to enter the driving-enabled state without stopping the engine.

When the operation state detecting unit 112 detects that the door is not unlocked by the remote control terminal 105 but by the key K in step SA102 (SA110), the engine stop determining procedure of step SA112 is performed at once. When the remote operation is performed by the door unlocking switch of the key K, it is determined that it is an authentic operator and the labor of restarting the engine is saved to increase convenience. When the door is unlocked by the manual operation of the key K, not by the remote operation, it is determined that it is not an authentic operator and the engine is stopped to enhance security.

The determination process of step SA102 is not necessary and the determination process of step SA110 instead of step SA102 may be performed at the position of step SA102.

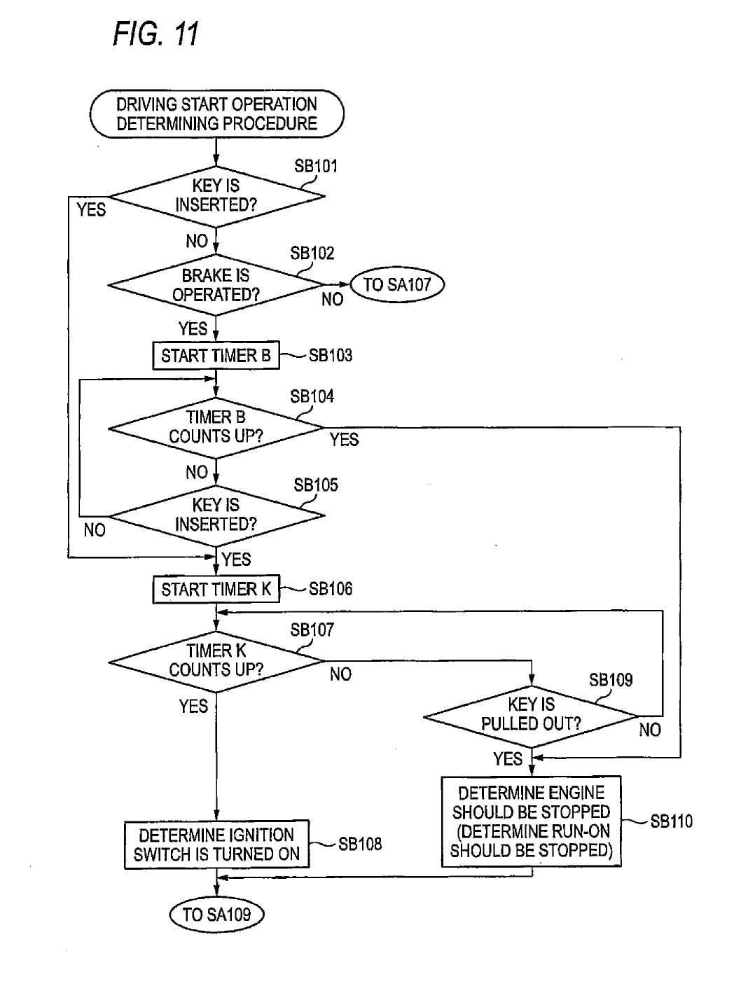

FIG. 11 shows the details of the driving start operation determining procedure of step SA108. When the brake pedaling operation is detected (SB102) until the operation state detecting unit 112 detects that the key K is inserted into the key cylinder KS by the operator (SB101), the remote control stopping unit 113 starts a timer B (SB103).

The timer B is a timer defining a delay time until the operator inserts the key K, and is used to forcibly stop the engine for the purpose of prevention of theft when the key K is not inserted into the key cylinder KS within the delay time. The value of the timer is set to, for example, about 3 seconds, but is not limited thereto.

When the timer 13 counts up (SB104), the remote control stopping unit 113 determines whether to stop the engine (SB110) and stops the remote starting control procedure, that is, turns off the relay circuit IG1 in step SA109. Accordingly, the engine is stopped.

When the operation state detecting unit 112 detects that the key K is inserted (SB105) until the timer B counts up (SB104), the remote control stopping unit 113 starts a timer K (SB106).

The timer K is a timer defining a delay time until the ignition switch IG is turned on after the operator inserts the key K, and is used to determine that the ignition switch IG is turned on when the delay time passes. The value of the timer is set to, for example, about 2 seconds, but is not limited thereto.

When the operation state detecting unit 112 detects that the key K is pulled out (SB109) until the timer K counts up (SB107), the remote control stopping unit 113 determines whether to stop the engine (SB110) and stops the remote starting control procedure, that is, turns off the relay circuit IG1 in step SA109. Accordingly, the engine is stopped.

When the timer K counts up (SB107), it is determined that the ignition switch IG is turned on (SB108) and stops the remote starting control procedure, that is, turns off the relay circuit IG1 in step SA109. When the ignition switch is turned on and until the timer K counts up, the engine is not stopped from entering a driving-enabled state.

That is, by considering that the ignition switch is turned on by the counting of the timer K, a dedicated detector circuit detecting the turning-on of the ignition switch IG due to the operation of the key K is not necessary. When the ignition switch is not turned on at the time of the counting-up of the timer K, the engine is stopped.

When the insertion of the key K is detected in step SB101, the process of step SB106 is performed. When the brake pedaling operation is not detected in step SB102, the process of step SA107 is performed and the engine is stopped due to the counting-up of the timer R (SA112 and SA109).

When the brake pedaling operation is stopped until the insertion of the key K is determined in step SB105, the engine stopping determining procedure of step SB110 may be performed. When the brake pedaling operation is stopped before inserting the key, it is determined that the operator does not have a driving intention or that it is based on the operation of an ill-intentioned third party.

To determine the braking pedaling operation in step SB102 is intended to enhance the convenience to the operator when the operator operates the key after operating the brake. If the engine is stopped at once by the remote starting device at the time of operating the brake before operating the key, it requests the authentic operator for a troublesome operation such as restarting the engine by means of the operation of the key.

One or all of the counting-up of the timer R in step SA107, the counting-up of the timer B in step SB104, and the counting-up of the timer K in step SB107 may be provided with a control step of detecting whether a predetermined banned operation is performed by the operator by the use of the operation state detecting unit 112 and performing the process of step SA112 by the use of the remote control stopping unit 113 when it is detected that any banned operation is performed. Here, examples of the predetermined banned operation include an accelerator pedaling operation and a switching operation of the shift lever into a driving range.

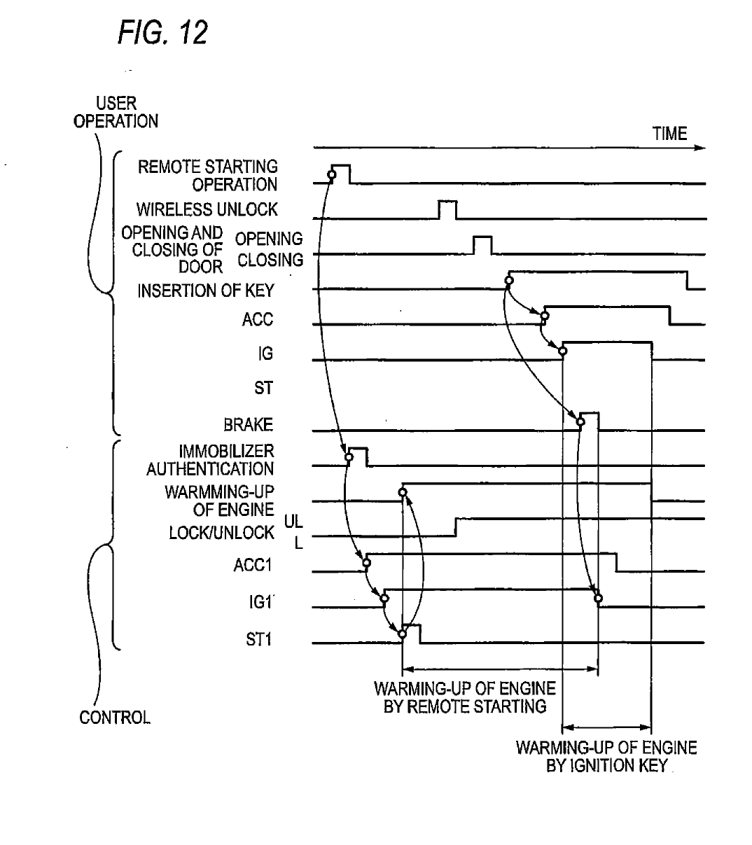

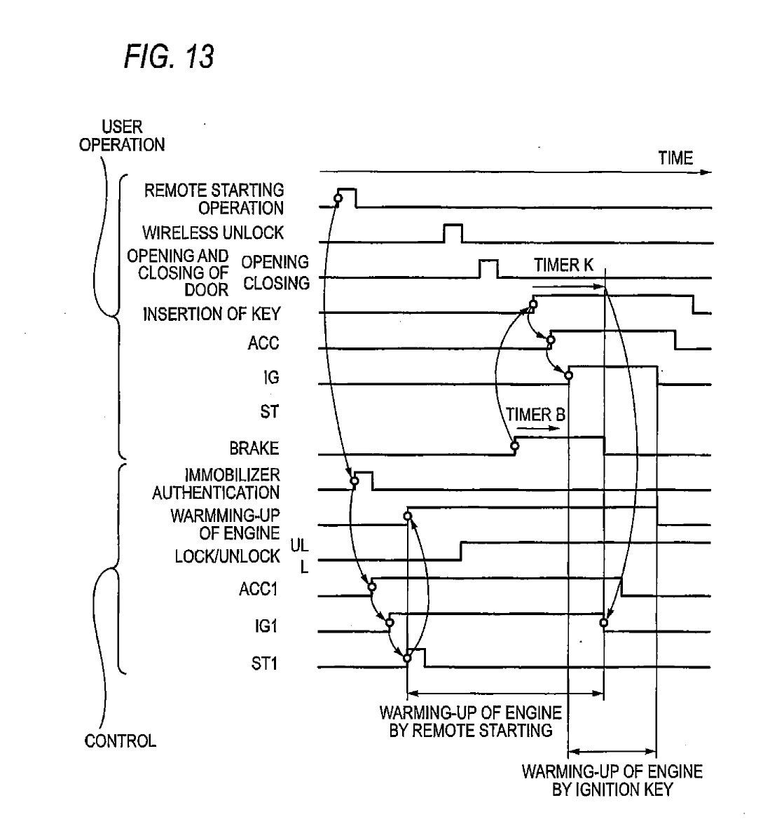

FIG. 12 is a timing diagram illustrating a sequence when the key inserting operation is performed after the brake pedaling operation is performed. FIG. 13 is a timing diagram illustrating a sequence when the brake pedaling operation is performed after the key inserting operation is performed.

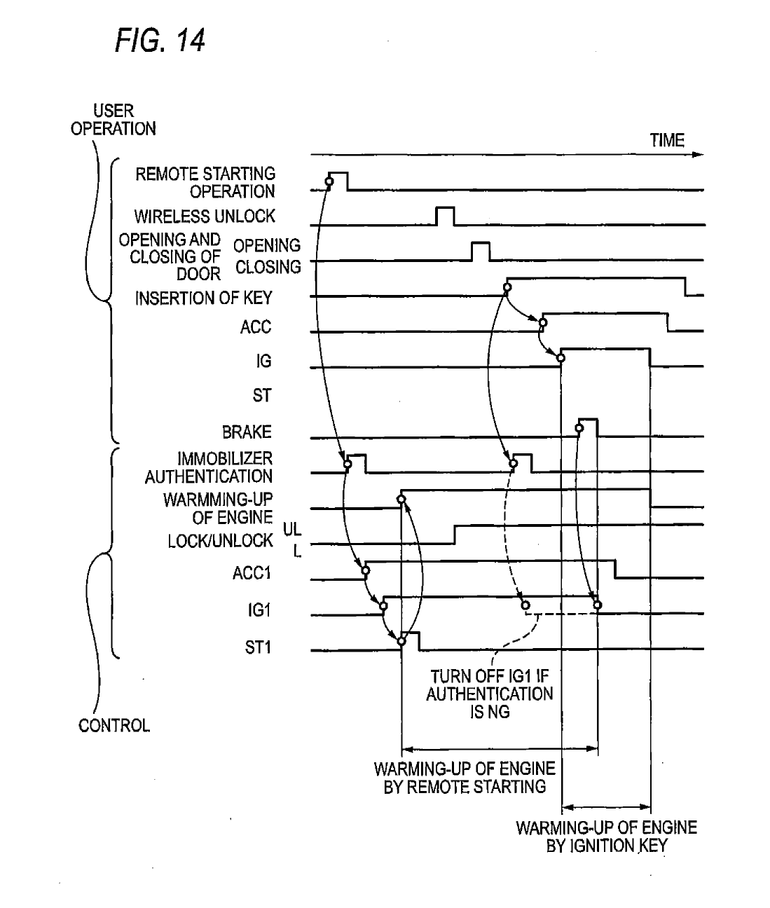

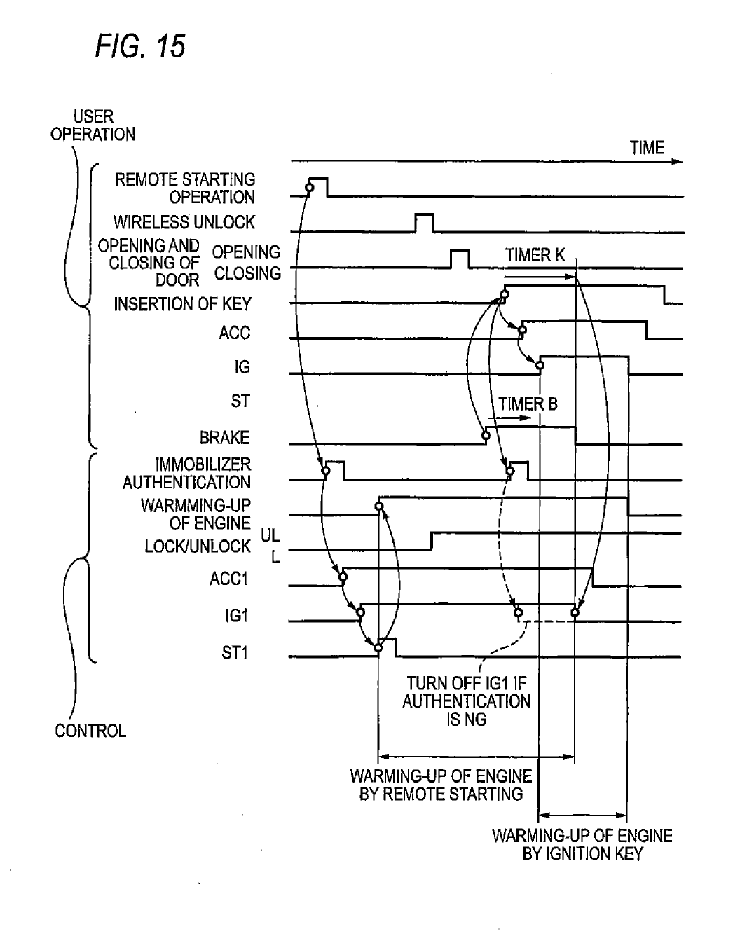

An authentication process using the immobilizer 102 may be performed at the same time as determining the insertion of the key K in step SB101 and SB105 and the process of step SA112 may be performed by the remote control stopping unit 113 when a signal representing that the authentication should not be allowed is received from the immobilizer 102 by the operation state detecting unit 112. In this case, it is determined that a counterfeit key is operated, thereby satisfactorily preventing theft. The timing diagram of this sequence is shown in FIGS. 14 and 15.

The immobilizer 102 reads the ID of the key via an antenna disposed around the key cylinder KS when the key K is inserted into the key cylinder KS.

As described above, the remote starting device according to the sixth embodiment of the invention is provided with the remote control stopping unit that turns off the remote control switch when the key inserting operation and the brake pedaling operation are detected by the operation state detecting unit after the engine is started up by the starting control unit.

The remote control stopping unit turns off the remote control switch when the insertion of the key is not detected even in a predetermined waiting time after the brake pedaling operation is detected by the operation state detecting unit, and turns off the remote control switch in a predetermined waiting time when the insertion of the key is detected.

When the insertion of the key is detected after the brake pedaling operation is detected by the operation state detecting unit and the stopping of the brake pedaling operation is detected until turning off the remote control switch, the remote control stopping unit turns off the remote control switch at once.

The remote control stopping unit determines that the ignition switch is turned on by the operator's insertion of the key and turns off the remote control switch when a predetermined waiting time passes after the insertion of the key is detected by the operation state detecting unit before or after the brake pedaling operation, and turns off the remote control switch when the brake pedaling operation is detected after the insertion of the key is detected by the operation state detecting unit.

The immobilizer determining whether the key is an authentic key is mounted on the vehicle. The remote control stopping unit turns off the remote control switch when a predetermined waiting time passes after the operation state detecting unit detects the insertion of the key and the immobilizer determines that the key is an authentic key, and turns off the remote control switch at once when the immobilizer determines that the key is a counterfeit key.

The remote control stopping unit turns off the remote control switch at once when the operation state detecting unit detects a predetermined banned operation until turning off the remote control switch, and turns off the remote control switch at once when the operation state detecting unit detects the pulling of the key until turning off the remote control switch after inserting the key.

An automatic door locking system is mounted on the vehicle. The remote control stopping unit turns off the remote control switch when a door is unlocked by the automatic door locking system and the insertion of the key is detected by the operation state detecting unit, and turns off the remote control switch at once when a door is unlocked without using the automatic door locking system.

Other embodiments of the invention will be described below.

Although the vehicle mounted with the immobilizer has been exemplified in the sixth embodiment, the invention may be applied to a vehicle not mounted with the immobilizer.

Although it has been stated in the sixth embodiment that a mechanical key K having an electronic chip storing a specific ID code built in the key head and including the door locking switch, the door unlocking switch, and the engine starting switch is used as the remote control terminal 105, the invention may be similarly applied to a case where a portable terminal (electronic key) called a smart key is used as the remote control terminal 105 instead of the mechanical key K.

In such a vehicle, when a push-type switch called a start switch which is a power switch activating a driving system of the vehicle is operated under the condition that it is authenticated that the portable terminal is an authentic portable terminal by communications between the portable terminal and the vehicle, the engine is started up.

The technical spirit of the invention may be applied to a hybrid vehicle having both an engine and a motor instead of the vehicle having only an engine as a driving source of the vehicle. In this case, when a brake is operated before operating the start switch, it is possible to enter a driving-enabled state without stopping the remotely-started engine.

An example of the hybrid vehicle will be described in detail below. The hybrid vehicle can be switched to a motor driving state under the condition that the engine efficiency is low. In this embodiment, for the purpose of easier understanding of the invention, it is assumed that the vehicle is driven by an engine, for example, when the capacity of a battery for the motor is lowered.

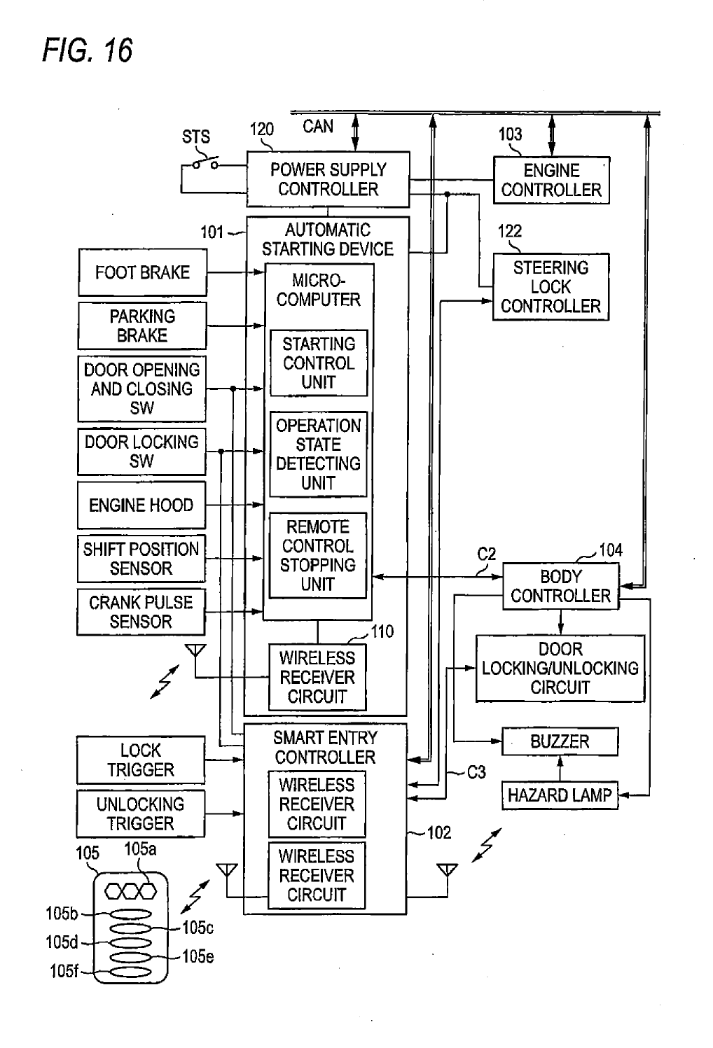

FIG. 16 shows important system configurations of a hybrid vehicle employing a smart entry system.

The vehicle includes electronic controllers such as a remote starting device 101, a smart entry controller 102, a power supply controller 120, a steering lock controller 122, an engine controller 103, a body controller 104, and a motor controller.

As in the sixth embodiment, each electronic controller includes a microcomputer having a CPU, a ROM storing a control program executed by the CPU, and a RAM storing control data or calculation data. The electronic controllers such as the power supply controller 120, the engine controller 103, and the body controller 104 are connected to each other so as to transmit and receive the control data via a vehicle network CAN (Controller Area Network).

The portable terminal as the remote control terminal 105 includes a display LED 105a and four types of operation switches and additionally includes a transmitter wirelessly transmitting the specific ID code stored in the electronic chip and control codes corresponding to the operation switches. The operation switches include a door locking switch 105b, a door unlocking switch 105c, an engine starting switch 105d, and an engine stopping switch 105e. For example, when the engine starting switch 105d is operated, an engine starting signal is transmitted therefrom. When the engine stopping switch 105e is operated, an engine stopping signal is transmitted therefrom.

The power supply controller 120 serves as a system controller of the hybrid vehicle and allows the activation of the system due to the operator's operation of the start switch STS on the condition that the operator is recognized as an authentic operator as the authentication result between the remote control terminal 105 carried by the operator and the smart entry controller 102.

The start switch STS formed of a push-type switch, is switched to an ACC mode in which accessories are supplied with power from the power supply controller 120 when it is turned on once, and is switched to an IG mode in which the controllers are supplied with power when it is turned on again in the ACC mode. In the IG mode, the controllers are activated but do not enter a driving state of the vehicle.

In the ACC mode or the IG mode, when the brake pedaling operation is performed and the start switch STS is turned on in this state, the operation state is switched to a ready mode in which the vehicle can be driven by the power supply controller 120. In the IG mode or the ready mode, when the start switch STS is turned on again, the operation state is switched to a system off state in which the supply of power is stopped by the power supply controller 120. The remote starting device 101, the power supply controller 120, and the smart entry controller 102 are supplied with power from the battery even when the system is turned off by the start switch STS.

The smart entry controller 102 includes a wireless receive circuit receiving a signal transmitted from the remote control terminal 105 and a wireless transmitter circuit transmitting a signal to the remote control terminal 105 and further includes an antenna used to communicate with the remote control terminal 105 outside the vehicle and an antenna used to communicate with the remote control terminal 105 inside the vehicle.

The remote starting device 101 is operated outside the vehicle, transmits an engine starting instruction to the engine controller 103 via the power supply controller 120 when an engine starting signal is received from the remote control terminal 105, whereby the engine is remotely started up. When an engine stopping signal transmitted from the remote control terminal 105 is received while remotely starting up the engine, the remote starting device transmits an engine stopping instruction to the engine controller 103 via the power supply controller 120, whereby the engine is stopped.

The steering lock controller 122 is a controller not permitting the steering operation for the purpose of prevention of theft of the vehicle by a third party in the state where the engine is remotely started up, and locks the steering until it is determined that a run-on operation is performed by an authentic user.

In this way, when an operator boards the vehicle in the state where the engine is remotely started up and intends to drive the vehicle, the operator pushes the start switch STS once to shift to the ready mode. However, when the brake pedaling operation is performed before turning on the start switch STS, the stopping of the engine deteriorates the convenience to the operator.

Therefore, the remote starting device includes a starting control unit that outputs a remote control signal to the engine controller to start up the engine when receiving the engine starting signal, an operation state detecting unit that detects at least the operation of the start switch and the breaking pedaling operation by the operator, and a remote control stopping unit that delays the off time of the remote control signal, when the brake pedaling operation is detected earlier than the operation of the start switch by the operation state detecting unit after the engine is started up by the starting control unit, but a predetermined condition is satisfied.

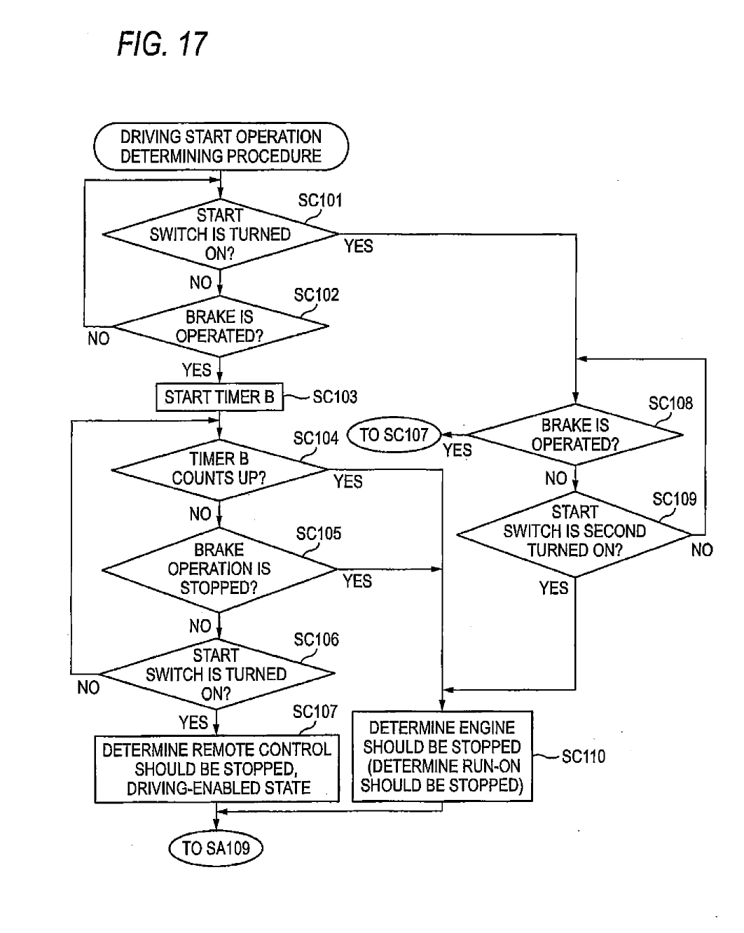

FIG. 17 shows the operations of the remote starting device corresponding to the operation of the start switch and the brake pedaling operation by the operator. The above-mentioned processes of steps SA101 to SA112 shown in FIG. 10 are performed prior to the procedure shown in FIG. 17, but they are almost the same and thus will not be described.

As shown in FIG. 17, when the brake pedaling operation is detected by the operation state detecting unit (SC102) before the start switch STS is turned on (SC101), the remote control stopping unit starts a timer B (SC103).

The timer B is a timer defining a delay time until the operator operates the start switch STS, and is used to forcibly stop the engine for the purpose of prevention of theft when the start switch STS is not operated within the delay time. The value of the timer is set to, for example, about 3 seconds, but is not limited thereto.

When the timer B counts up (SC104), the remote control stopping unit determines whether to stop the engine (SC110) and stops the remote starting control procedure, that is, stops the engine in step SA109 shown in FIG. 10.

When the operation state detecting unit detects that the brake pedaling operation is stopped (SC105) until the timer B counts up (SC104), the remote control stopping unit similarly determines whether to stop the engine (SC110) and stops the remote starting control procedure, that is, stops the engine in step SA109 shown in FIG. 10. When it is detected that the brake pedaling operation is not stopped and the start switch STS is turned on (SC106), the remote control stopping unit determines that the remote control should be stopped and stops the remote control (SC107). At this time, since the read mode is entered by the turning-on operation of the start switch STS, the engine is kept in the started-up state. The locked state of the steering is released by the steering lock controller 122 at this time.

When the start switch STS is turned on in step SC101, the remote control stopping unit waits for the brake pedaling operation (SC108). When the operation state detecting unit detects the brake pedaling operation, the remote control stopping unit determines that the remote control should be stopped and stops the remote control (SC107). At this time, since the ready mode is entered by the turning-on operation of the start switch STS, the engine is kept in the started-up state.

When the second turning-on of the start switch STS is detected (SC109) until the brake pedaling operation is detected in step SC108, the remote control stopping unit determines whether to stop the engine (SC110) and stops the remote starting control procedure, that is, stops the engine in step SA109 shown in FIG. 10. That is, it is determined that the operator does not have a driving intention.

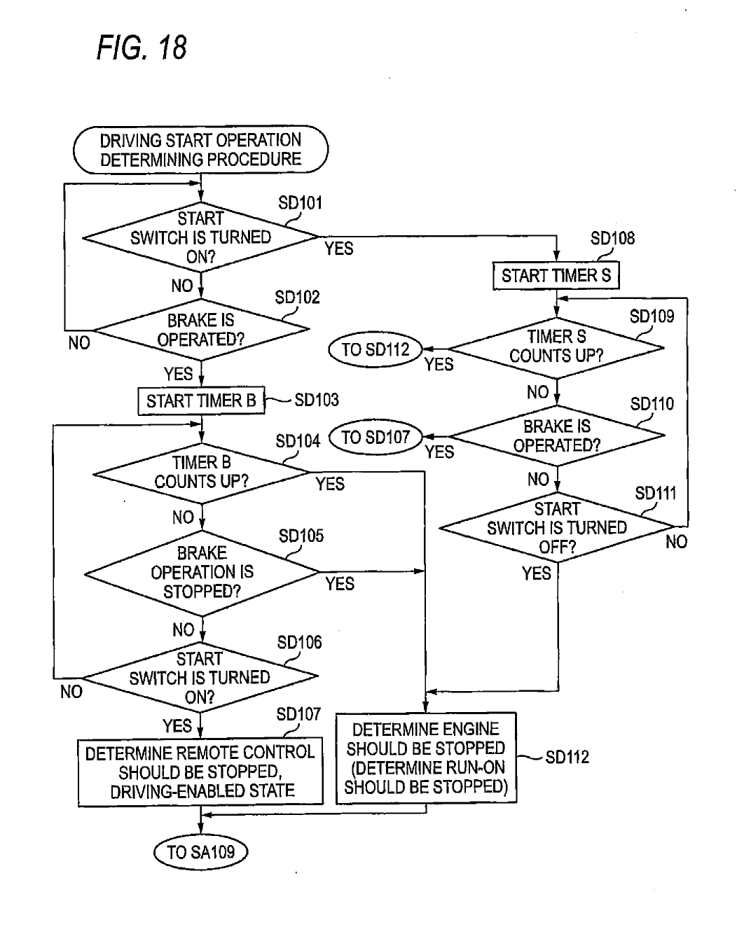

FIG. 18 shows another example of the operations shown in FIG. 17. When the start switch STS is turned on in step SD101, the remote control stopping unit starts a timer S (SD108).

The timer S is a timer defining a delay time until the operator operates the brake after operating the start switch STS, and is used to forcibly stop the engine when the brake is not operated within the delay time. The value of the timer is set to, for example, about 3 seconds, but is not limited thereto.

When the timer S counts up (SD109), it is determined that the operator does not have a driving intention, it is determined that the engine should be stopped (SD112), and the engine is stopped in step SA109 shown in FIG. 10.

When the brake pedaling operation is detected (SD110) until the timer S counts up, the remote starting control procedure is stopped in the driving-enabled state where the engine is started up in step SA109.

When it is detected that the start switch STS is turned off (SD111) until the timer S counts up, the process of step SD112 is performed in a similar way.

The remote starting control stopping process of step SA109 performed after steps SD107 and SD112 will be described below. When it is determined in step SD107 that the remote control is stopped in the driving-enabled state, the control signal representing the determination is transmitted to the power supply controller 120 from the remote starting device 101 and the power supply controller 120 switches the operation mode to the ready mode to keep the engine controller 103 in the started-up state. That is, the operator can drive the vehicle at any time. When it is determined in step SD112 that the engine should be stopped, the control signal representing the determination is transmitted to the power supply controller 120 from the remote starting device 101 and an engine stopping instruction is given to the engine controller 103 from the power supply controller 120. At this time, the power supply controller 120 switches the operation mode to a state where the system is powered off.

That is, the remote starting device includes the starting control unit that starts up the engine when receiving the engine starting signal, the operation state detecting unit that detects at least the operator's operation of the power supply switch of the vehicle system and the brake pedaling operation, and the remote control stopping unit that stops the remote control procedure when the operation of the power supply switch is detected before or after the brake pedaling operation is detected by the operation state detecting unit after the engine is started up by the starting control unit.

The remote control stopping unit stops the remote control procedure when the operation of the power supply switch is not detected in a predetermined waiting time after the brake pedaling operation is detected by the operation state detecting unit, and stops the remote control procedure when the stopping of the brake pedaling operation is detected until the operation of the power supply switch is detected by the operation state detecting unit. In both cases, the engine is stopped.

The remote control stopping unit stops the remote control procedure in a predetermined waiting time when the operation of the power supply switch is detected after the brake pedaling operation is detected by the operation state detecting unit. In this case, since the ready mode is entered, the engine is kept in the started-up state.

The remote control stopping unit stops the remote control procedure when the brake pedaling operation is detected after the operation of the power supply switch is detected by the operation state detecting unit. In this case, since the ready mode is entered, the engine is kept in the started-up state.

As described above, the remote control stopping unit selects one operation of stopping the remote starting control procedure in the state where the engine is started up so as to improve the convenience to the user and stopping the remote starting control procedure in the state where the engine is stopped so as to prevent theft by a third party, on the basis of the operation state of the brake and the operation state of the start switch.

The sixth embodiment and the other embodiments described above are examples of the invention. The specific configurations of the functional blocks, the settings of the timer values, and the like can be appropriately changed in design depending on remote starting devices to be employed without departing from the scope in which the operational advantages of the invention can be obtained.

What is claimed is:

1. A remote starting device that starts up an engine of a vehicle when receiving an engine starting signal wirelessly transmitted from a remote control terminal, the remote starting device comprising:
a starting control unit that turns on a remote control switch disposed in a path through which power is supplied to ignition devices from a battery to supply power to the ignition devices and to start up the engine when receiving the engine starting signal;
an operation state detecting unit that detects at least a key insertion operation of inserting a key into a key cylinder and a brake pedaling operation of depressing a brake pedal, by an operator; and
a remote control stopping unit that turns off the remote control switch when stopping of the brake pedaling operation is detected after the engine is started up and the key insertion operation and the brake pedaling operation are detected.

2. The remote starting device as set forth in claim 1, further comprising:
an authentication unit that authenticates a signal transmitted from one of a wireless key and a smart key; and
an unlocking unit that allows a door of the vehicle to be unlocked when a result of the authentication by the authentication unit is a success,
wherein the remote control stopping unit turns off the remote control switch when the stopping of the brake pedaling operation is detected after the key insertion operation and the brake pedaling operation are detected in a state where the engine is started up and the door is allowed to be unlocked.

3. The remote starting device as set forth in claim 1,
wherein the operation state detecting unit further detects a position of a shift lever operated by the operator, and
wherein the remote control stopping unit turns off the remote control switch when it is detected that the position of the shift lever is disengaged from a perking position after the engine is started up and the key insertion operation and the brake pedaling operation are detected.

4. The remote starting device as set forth in claim 1,
wherein the remote control stopping unit turns off the remote control switch when the insertion of the key is not detected after the engine is started up and the key insertion operation and the brake pedaling operation are detected.

5. A remote starting device that starts up an engine of a vehicle when receiving an engine starting signal wirelessly transmitted from a remote control terminal, the remote starting device comprising:
a starting control unit that starts up the engine by remote control when receiving the engine starting signal;
an operation state detecting unit that detects at least a switch operation on a power supply switch of a vehicle system and a brake pedaling operation of depressing a brake pedal, by an operator; and
a remote control stopping unit that stops the remote control when the switch operation is detected after the engine is started up and the brake pedaling operation is then detected.

6. The remote starting device as set forth in claim 5, wherein the remote control stopping unit stops the remote control when the switch operation is detected after the engine is started up.

7. A remote starting method for starting up an engine of a vehicle when receiving an engine starting signal wirelessly transmitted from a remote control terminal, the remote starting method comprising:
(a) turning on a remote control switch disposed in a path through which power is supplied to ignition devices from a battery to supply power to the ignition devices and to start up the engine when receiving the engine starting signal;
(b) detecting at least a key insertion operation of inserting a key into a key cylinder and a brake pedaling operation of depressing a brake pedal, by an operator; and
(c) turning off the remote control switch when stopping of the brake pedaling operation is detected after the engine is started up and the key insertion operation and the brake pedaling operation are detected.

8. A remote starting method for starting up an engine of a vehicle when receiving an engine starting signal wirelessly transmitted from a remote control terminal, the remote starting method comprising:
(a) starting up the engine by remote control when receiving the engine starting signal;
(b) detecting at least a switch operation on a power supply switch of a vehicle system and a brake pedaling operation of depressing a brake pedal, by an operator; and
(c) stopping the remote control when the switch operation is detected after the engine is started up and the brake pedaling operation is then detected.

9. A remote starting device that starts up an engine of a vehicle when receiving an engine starting signal wirelessly transmitted from a remote control terminal, the remote starting device comprising:
a starting control unit that turns on a remote control switch disposed in a path through which power is supplied to ignition devices from a battery to supply power to the ignition devices and to start up the engine when receiving the engine starting signal;
an operation state detecting unit that detects at least a key insertion operation of inserting a key into a key cylinder and a brake pedaling operation of depressing a brake pedal, by an operator; and
a remote control stopping unit that turns off the remote control switch when the key insertion operation and the brake pedaling operation are detected by the operation state detecting unit after the engine is started up by the starting control unit.
